(19) United States
(12) Patent Application Publication
(10) Pub. No.: US 2008/0120041 A1
(43) Pub. Date: May 22, 2008

(54) SYSTEM AND METHOD TO IDENTIFY THE METABOLITES OF A DRUG

(75) Inventors: Lars-Olaf Ridder, Oss (NL); Markus Wagener, Oss (NL); Johannes Petrus Maria Lommerse, Oss (NL)

Correspondence Address: ORGANON USA, INC.;PATENT DEPARTMENT, 56 LIVINGSTON AVENUE, ROSELAND, NJ, 07068, US

(73) Assignee: N.V. Organon, Oss (NL)

(21) Appl. No.: 11/938,418

(22) Filed: Nov. 12, 2007

Related U.S. Application Data
(60) Provisional application No. 60/948,534, filed on Jul. 9, 2007.

(30) Foreign Application Priority Data
Nov. 13, 2006 (EP) 06123913.3

(51) Int. Cl. G06F 19/00

(52) U.S. Cl. 702/19; 702/22

(57) ABSTRACT

The invention provides for a method for predicting potential metabolites for a compound, comprising the steps of receiving a target compound from a user applying a set of optimized reaction rules to said target compound to generate a list of potential metabolites and calculating a probability score for each product compound on said list of potential metabolites. The reaction set is optimized by starting from a starting set of reaction rules and replacing at least one reaction rule for a reaction center in said starting set of reaction rules by one, or preferably two or more new rules, which are defined to apply to a reaction of said reaction center, but now specifying or differentiating based on the structural environments of said reaction center, if at least one of said new rules has a higher probability score than the replaced reaction rule when the starting set of reaction rules and the optimized set of reaction rules are both tested with a database of known metabolites of compounds.

### FIELD OF THE INVENTION

The invention relates to a system and method to identify the metabolites of a drug in a mammalian body by entering the structural formula of the drug into a computer program, which computer program provides the structural formulas of possible metabolites by screening for possible metabolic transformations and the probabilities thereof for the drug and the invention relates to the use of such a method by implementing the method in a mass spectrometry (MS) instrument.

### BACKGROUND OF THE INVENTION

Identification of metabolites is an important aspect in drug discovery and development at various stages of the process. Early in discovery, metabolite identification is often required to support the chemical optimization towards metabolically stable compounds. Later in discovery and in development it is essential to investigate the metabolic profile of a compound and to study possible activity and/or toxicity of major or human specific metabolites. Prediction of metabolites can assist these activities in several ways. Early metabolite screening can be facilitated significantly by predictions. For example, fast liquid- or gas-chromatography/mass spectrometry (LC/MS or GC/MS) experiments can be setup to specifically detect predicted metabolites, which allows a relatively simple experimental setup and data analysis. Prediction methods can subsequently be used to further interpret the results and to assess possible chemical modifications to block the metabolically labile sites. Furthermore, recent developments demonstrate that metabolite prediction in combination with MS fragment ion prediction can be used to support the analysis of the complex LC/MSⁿ or GC/MSⁿ data data resulting from full metabolite identification experiments. Prediction of metabolites can assist these activities in several ways, which is especially important in the absence of radiolabeled compound (e.g. during Research and early development)

Different methodologies to predict metabolites or sites of metabolism have been reported recently. The metabolic fate of a molecule depends on its chemical reactivity towards several metabolic process that can occur, as well as on its interactions (affinity and binding orientation) with the biotransformation enzymes involved. Computational methods to predict the outcome of this complex problem maybe divided into the following categories.

1) A large amount of effort goes into methodologies to predict metabolites on the basis of calculations of (relative) chemical reactivities of different sites in a molecule. It is well established that calculated energies of hydrogen radical abstraction (e.g. by approximate quantum chemical methods) are a useful indicator of the metabolic lability of different aliphatic positions towards a range of cytochrome P450 catalyzed reactions. Other calculations are used to assess the regioselectivity of aromatic hydroxylations by P450 enzymes. Frontier orbital theory, or Fukui calculations have been applied to predict regioselectivity of aromatic hydroxylation or to identify metabolically labile sites in complete molecules. Docking has been used to predict the binding mode of ligands for CYP 2D6 and the predicted exposure to the reactive heme cofactor was shown to correlate with the known sites of metabolism of the ligands. In a less explicit approach, a GRID-based (binding-)interaction pattern of the CYP 2C9 active site was matched to those of its substrates to predict likely sites of metabolism. These methods are attractive as they may be able to make predictions for new compound classes with chemical features for which no metabolic studies have been performed before. However, most of these are limited to P450 catalyzed reactions and often only indicate labile sites, rather than predicting the actual metabolites formed.

2) Knowledge or rule based methods rely on metabolic rules derived by experts. Examples of this methodology are MetabolExpert, Meteor, Metadrug, Ekins, 2005 3/id; Ekins, 2006 4/id} and KnowItAll. These methods have the advantages of being potentially fast and to generate actual structures of metabolites. However, these methods often generate large numbers of “false” metabolites since large sets of metabolic rules are being applied and therefore provide limited information to chemists in identifying labile sites in a molecule.

For rule-based methods to be useful in identifying major metabolism and improving metabolic stability in lead optimization it is important to limit the number of predictions to only the likely metabolites or to provide a reliable ranking of the metabolites in order of decreasing likeliness. At the same time, application of rule-based methods to support analysis of experimental metabolite data requires the predictions to be as complete as possible, i.e. including as many as possible of the experimental metabolites one could find experimentally. For a rule-based method to serve both application areas the optimal output is an extensive but complete list of potential metabolites which is however accurately ranked in order of decreasing likeliness. The rules for a rule based method may also be derived by applying statistical analysis on a large database of experimental metabolic reactions. Based on such analysis, empirical probabilities are obtained which indicate the likeliness that a certain site in a molecule will be metabolized. The PASS-BioTransfo program provides a likeliness that a certain class of biotransformation reaction will occur. The Sporcalc approach ranks sites in a molecule according to likeliness of undergoing metabolism. {Hasselgren Arnby, 2005 11 /id} Also, a number of other methods have been described, e.g. TIMES and Metadrug, that provide a probability of predicted metabolites to be formed. Although some of the existing methods have implemented a crude differentiation between likely and unlikely metabolites, the existing methods have their limitations both in terms of completeness and accuracy of ranking. Thus, there exists a need for a prediction method which combines the advantages of systematically generating a complete list of potential metabolite structures, at low computational cost, with an accurate ranking to differentiate between more and less likely metabolites.

### SUMMARY OF THE INVENTION

The present invention applies reaction rules to generate an exhaustive list of potential metabolites of a compound in a biological system. Each rule is statistically evaluated on the basis of a large dataset of experimental data, resulting in an empirical probability score. The invention also provides for a process to optimize the reaction rules and their corresponding probabilities with respect to a training data set. The rules set is a set of optimized reaction rules in the sense that it is ensured that each rule in the set meets certain standards before becoming a part of the reaction rule set that is used in the invented prediction tool. The resulting prediction tool, ranks predicted metabolites based on the probability scores. It systematically generates a complete list of metabolite structures, at low computational cost, which are accurately ranked on decreasing likeliness.

Thus the present invention is a method to identify the metabolites of a drug (target compound) in a biological system, for example a mammalian body, which is preferably a human body, by entering the structural formula of the target compound into a computer program, which computer program provides the structural formulas of possible metabolites by screening for possible metabolic transformations and the probabilities thereof for the drug by using a list possible metabolic transformations and the probabilities of those transformations, characterized in that the list contains subsets (or named subcategories) of metabolic transformations depending on the position of the modified part of the drug in the structure of the drug. The method as described here is also referred to below as SyGMa (Systematic Generation of Metabolites).

The precision of the method is to such an extent that it is sensible to couple the program to the data acquisition and/or data processing software on a mass spectrometer for data processing. This coupling can take different forms. In one application the predicted metabolites can be used to set up a mass spectrometer in “single or multiple reaction monitoring” mode to detect specifically one or multiple metabolite(s) with the predicted mass characteristics in in vitro or in vivo samples. This method is both selective and sensitive and can be applied efficiently on a large number of compounds/samples in an early phase of drug discovery even when minor components in a biological matrix. Besides reaction monitoring on a triple quadrupole or linear ion trap mass spectrometer other mass spectrometric techniques applied for metabolite identification, either at nominal or accurate mass or combinations thereof, can also be used to detect predicted metabolites including those on single quadrupole, 3D-ion trap, linear ion trap, orbitrap, FT-ICR, magnetic sector, time-of-flight as well as multiple and hybrid mass analysers. Samples can be introduced into the mass spectrometer in several ways including infusion, liquid chromatography, gas chromatography, capillary electrophoresis or multiple stages of separation combined.

In another application, for data processing, the predicted metabolite structures and/or calculated mass characteristics thereof can be imported into mass spectrometry data processing analysis software to confirm their presence in complex MS data, since the existing analysis and interpretation of MS data sets on complex mixtures such as metabolite samples are often very labor intensive and the described use of predicted metabolites can increase the efficiency and accuracy of this process.

### BRIEF DESCRIPTION OF THE DRAWINGS

FIG. 1 depicts the data processing units that can implement one embodiment of the present invention.

FIG. 2 depicts a flow chart depicting one embodiment of the present invention.

FIG. 3a depicts one screen of one embodiment of the graphical user interface used in accordance with the present invention.

FIG. 3b describes another screen of one embodiment of the graphical user interface used in accordance with the present invention.

FIG. 3c depicts another screen of one embodiment of the graphical user interface used in accordance with the present invention.

FIG. 3d depicts another screen of one embodiment of the graphical user interface used in accordance with the present invention.

FIG. 4a depicts a flow chart illustrating the steps of one embodiment of the present invention.

FIG. 4b depicts a flow chart illustrating the steps of the Rule Application Process used in one embodiment of the present invention.

FIG. 5 depicts a flow chart illustrating the Rules Optimization Process used in one embodiment of the present invention.

FIG. 6 depicts one example of the Rule Refinement Process used in one embodiment of the present invention.

FIG. 7a illustrates the (augmented) atom types used in a study of the reaction fingerprint for propanol.

FIG. 7b illustrates the reaction fingerprint, representing the difference between the atomic fingerprints of reactant (1-propanol) and product (propane-1,3-diol).

FIG. 8a is a graph of the fraction of all metabolites in the training set that are reproduced as function of the number of predicted metabolites from the top of the ranking list.

FIG. 8b presents a graph similar to FIG. 8a, but not for the training set but for the test set.

FIG. 9 depicts the top 10 of “most probable” reactions.

FIG. 10 depicts charts showing the probability scores for metabolic rules calculated based on a) human in vitro data and b) in vivo rat data plotted against in vivo human probabilities based on in vivo data.

FIG. 11 shows the different major metabolic routes of anilines in vivo and in vitro.

### DETAILED DESCRIPTION

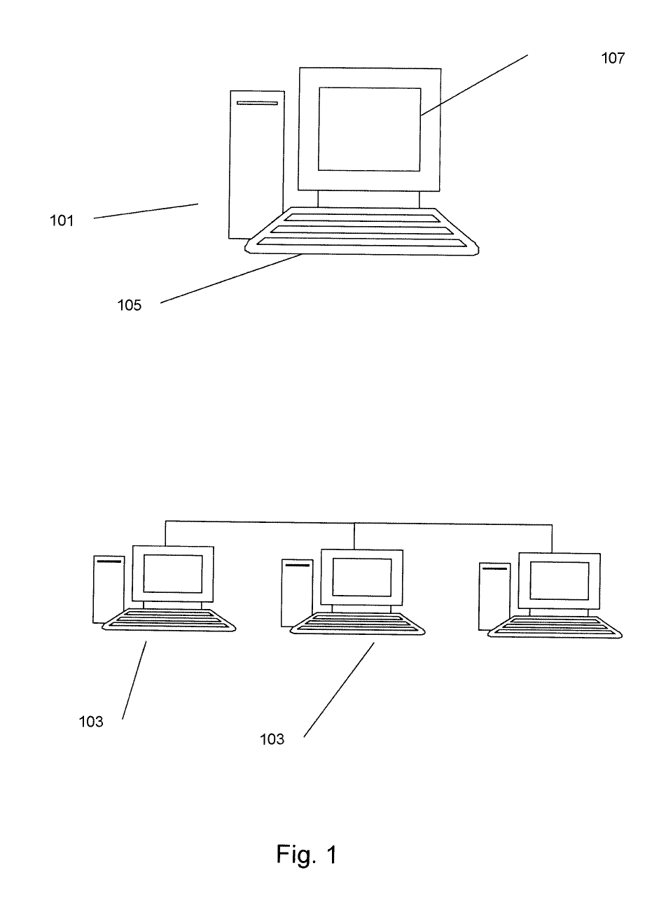

FIG. 1 depicts a data processing system that can be used to implement one embodiment of the present invented system. The data processing system can be a solitary computer 101 or a network of computers 103 as long as data storage and data processing capabilities exist in the system. The data processing system should also have user input device 105 such as a keyboard or a mouse to enable the user to input information to identify the particular compound desired to be analyzed by the present invention. Additionally, a means for displaying the results of the analysis, such as a display monitor 107, should be available as well.

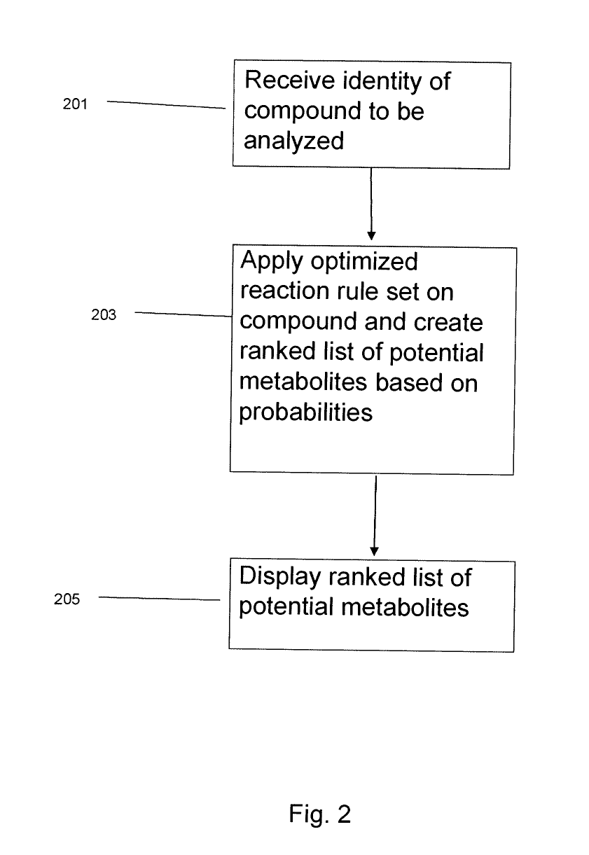

Referring to FIG. 2, the first step 201 of one embodiment of the present invention involves receiving input from the user to identify the compound to be analyzed. The information input from the user can take various forms. The input could be (1) a drawn figure, (2) a structure file, e.g. SDF file, MOL file, but other formats could be possible, or (3) an identifier that identifies the structure in an associated database. Ideally, the user will input the chemical structure.

In step 203, a set of reaction rules will be applied to the compound to determine the potential metabolites. The term ‘set of reaction rules’ as used in this specification is synonym with the term ‘list of possible metabolic transformations’ even though it may turn out that by the nature of the compound particular metabolic transformations are not possible for the compound. In one embodiment of the present invention, the reaction rules have been encoded in the Daylight SMIRKS language. The set of reaction rules is used to systematically apply a set of rules on a compound structure for a specified number of subsequent steps to build up a complete reaction tree. A SMIRKS rule consists of a molecular substructure query (the “reactant side”) and a definition of how the matching substructure is to be modified in the resulting product (the “product side”). An example of a SMIRKS rule is shown below with the structural representation above it:

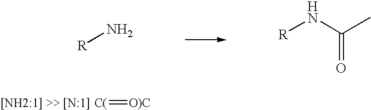

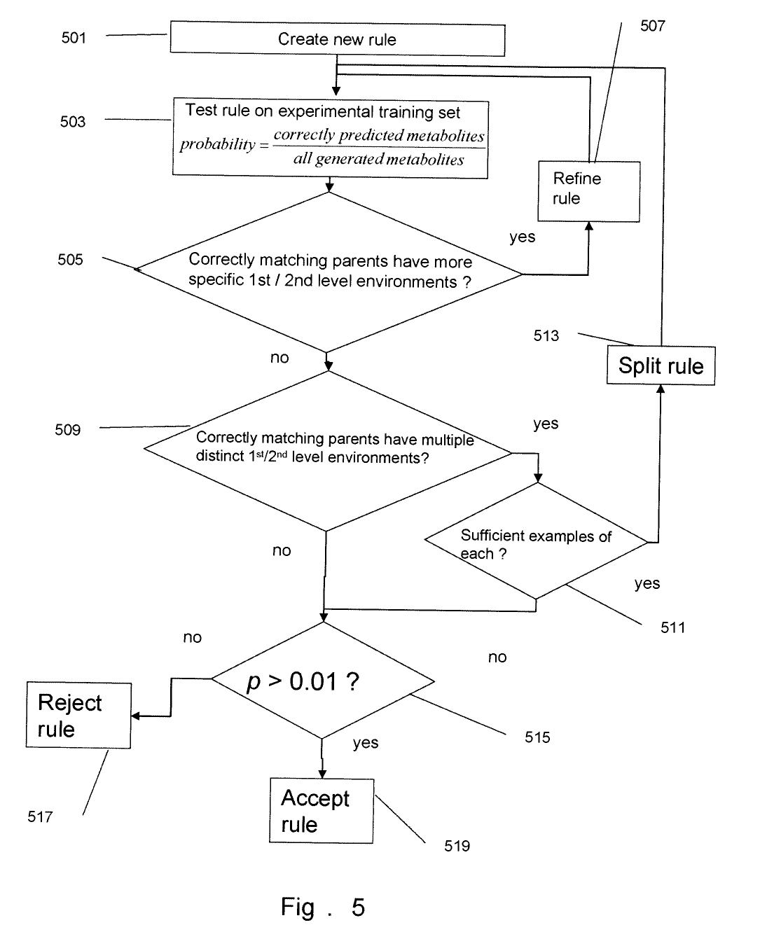

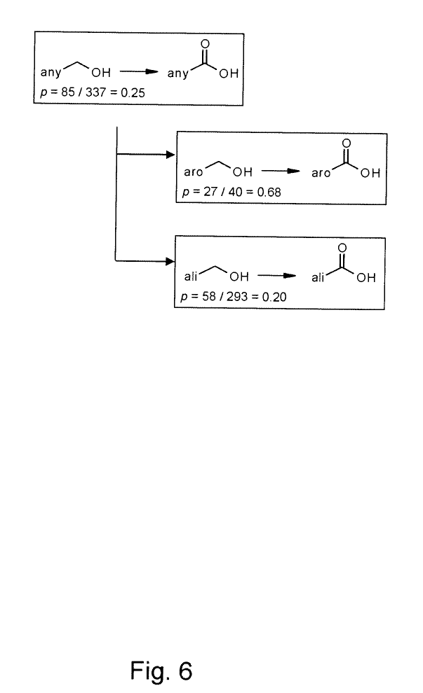

The above SMIRKS rule provides a simple example of a reaction rule for N-acetylation. Atoms that are preserved in the reaction are matched between the reactant and product side by means of numeric labels (indicated by a colon). Disappearing atoms on the reactant side and appearing atoms on the product side are not labeled. Furthermore, the SMIRKS language enables flexible query definitions, defining e.g. element, valency, aromaticity, charge and ring membership of atoms and e.g. bond-order and ring-membership of bonds. This allows the definition of rules that apply to reaction centers with more general or more specific chemical environments. Each rule of the Reaction Rule Set will have a probability score assigned to it. The probability score is assigned to it as part of the Reaction Rule Set optimization process that will be described in relation to FIGS. 5 and 6. Once the Optimized Reaction Rule Set has been applied and a list of potential metabolites have been created and ranked according to the probability score calculated for each potential metabolite, then the ranked list of potential metabolites will be displayed to the user in the Display Ranked List step 205.

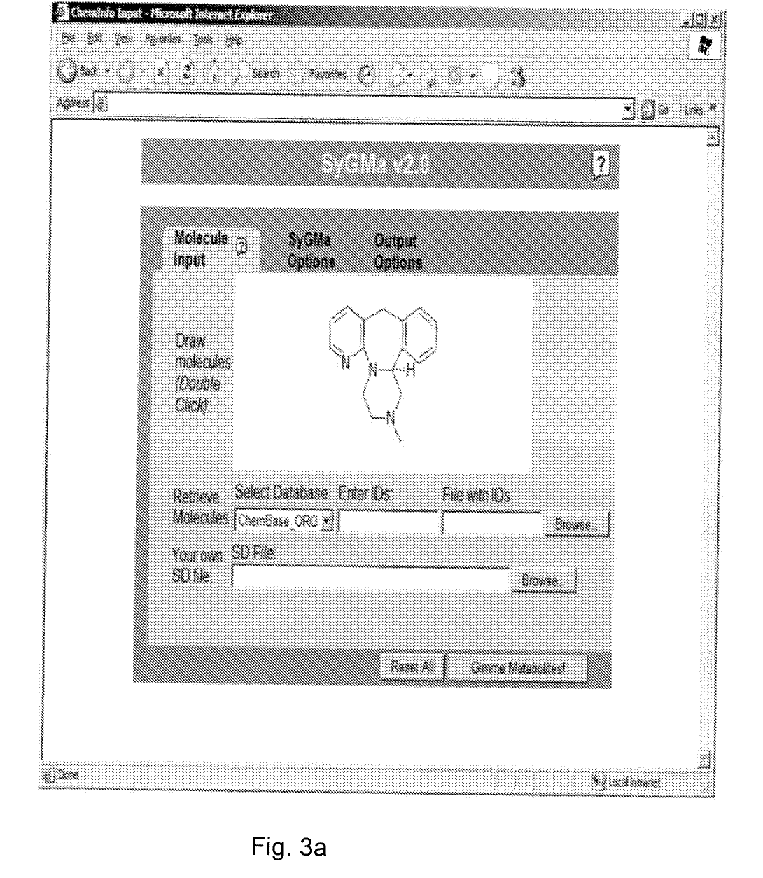

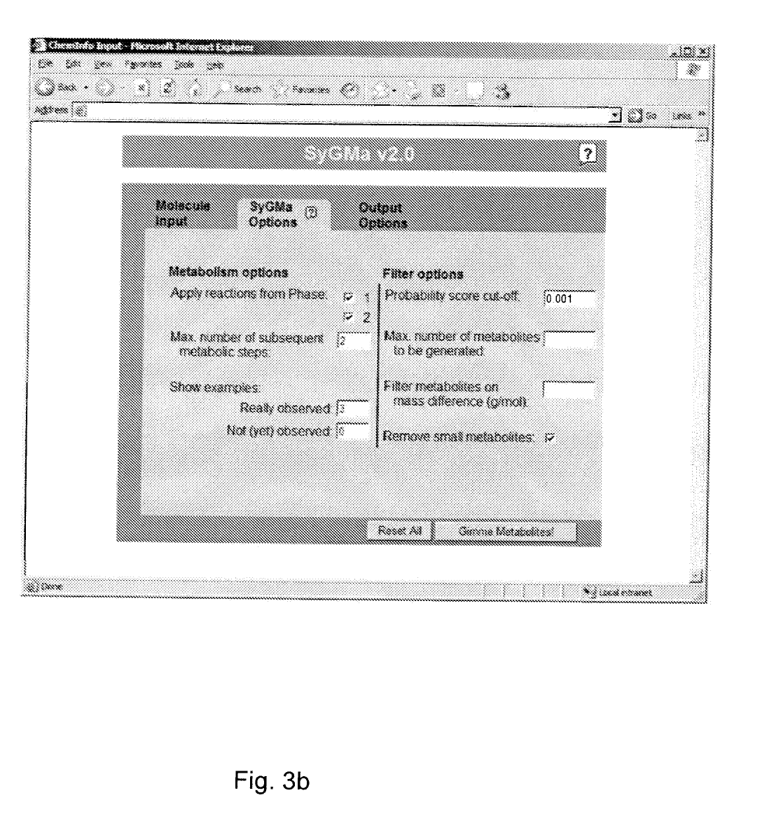

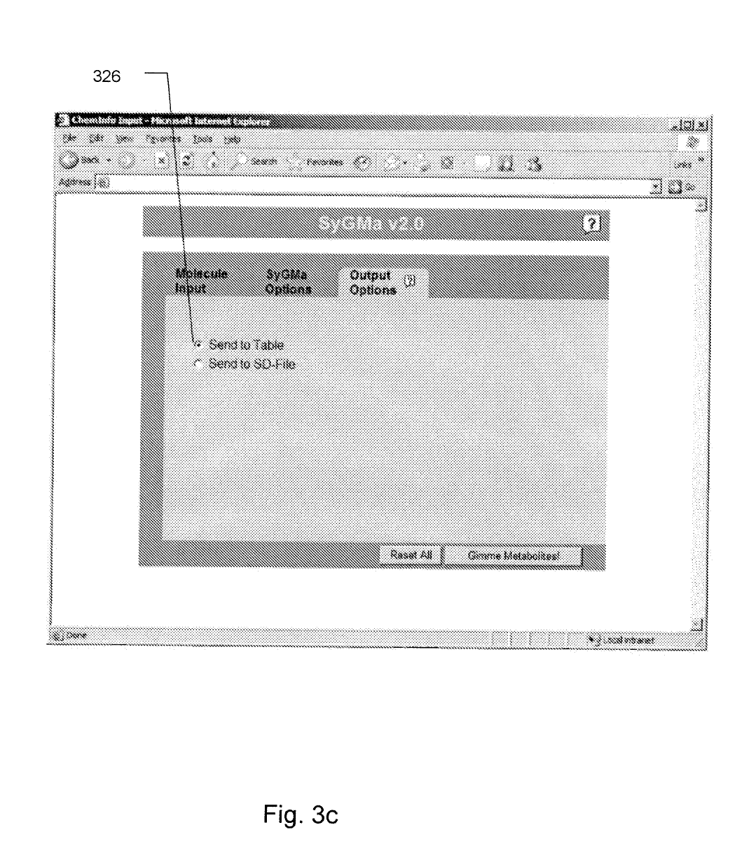

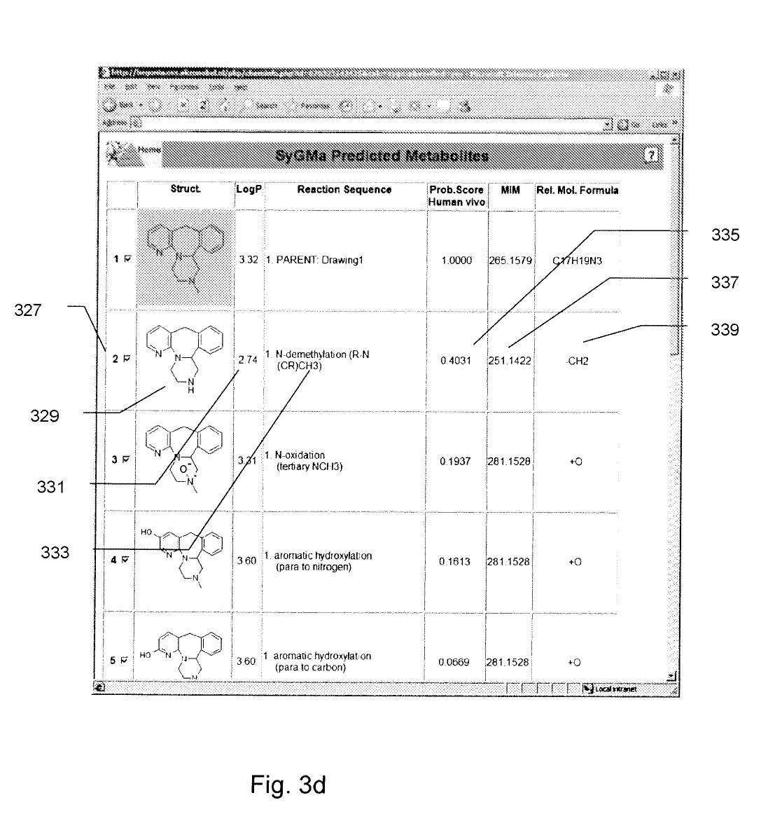

FIGS. 3a-3d depict one embodiment of the graphical user interface (GUI) that can be used in accordance with the present invention. FIG. 3a depicts the screen that allows the user to input the compound to be analyzed. Input box 301 allow the user to draw the molecule to be analyzed. Optionally, the user can use input fields 303 to input a code that will identify the compound from an associated database or associate a file within other applications. Lastly, the user can input a file in input field 305 that contains the information to identify the target compound. Tabs 307 and 309 allow the user to switch to the “SYGMA Options” screens and “Output Options” screen respectively. Buttons 311 and 313 allow the user to reset all information and to begin the metabolite analysis, respectively.

FIG. 3b depicts the screen showing how the user can set the options to be used in creating the list of metabolites in accordance with one embodiment of the present invention. In user selection boxes 315, the user can specify if reactions from phase 1 and/or 2 should be used. User selection field 317 allows the user to limit the number of subsequent metabolic steps to be used in generating the potential metabolite list. This limits the amount of recursive steps the Reaction Rule Set application process performs on the metabolites themselves. In user input boxes 319, the user specifies if it is desired to obtain experimental examples of metabolic reactions similar to the predicted reactions. In user input box 321, the user can designate a filter that will eliminate any potential metabolites that fall below a certain calculated probability score. Such a filter can be set on a certain limit, e.g. a probability score below 0.05, or 0.01 or 0.005. The user box 323 allows the user to set a maximum number of metabolites to be generated and user box 325 allows the user to filter the list of potential metabolites on the mass difference. In FIG. 3c depicts the Output Options screen. Option 326 allows the user to send the output to a table and option 330 allows the user to send the output to an SD-file.

FIG. 3d depicts one screen showing the results of the metabolite prediction in one embodiment of the present invention. The ranking 327 is shown of each potential metabolite. The first listed is typically the compound analyzed. The chemical structure of the metabolite 329 is shown in the next column. Reference number 331 provides the calculated log P (measure for lipophilicity). Reference numbers 333 and 335 are the sequence of rules that have been applied to yield the predicted structure in column 329 and the score respectively. Reference number 337 displays the monoisotopic mass of the metabolite which corresponds to the mass measured in accurate mass-spectrometry. Reference number 339 displays the molecular formula for the parent, or the difference in molecular formula of a predicted metabolite relative to the parent.

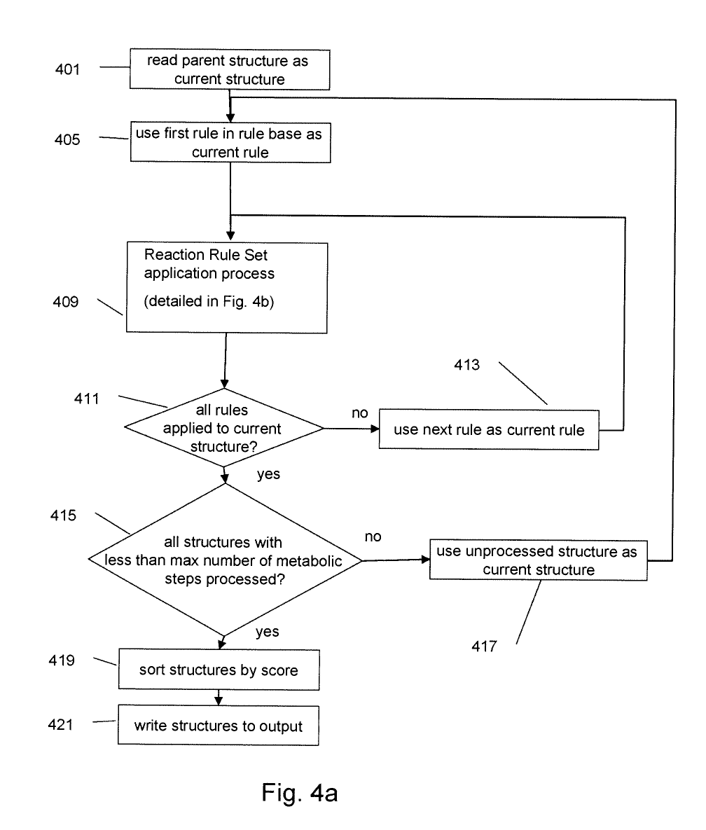

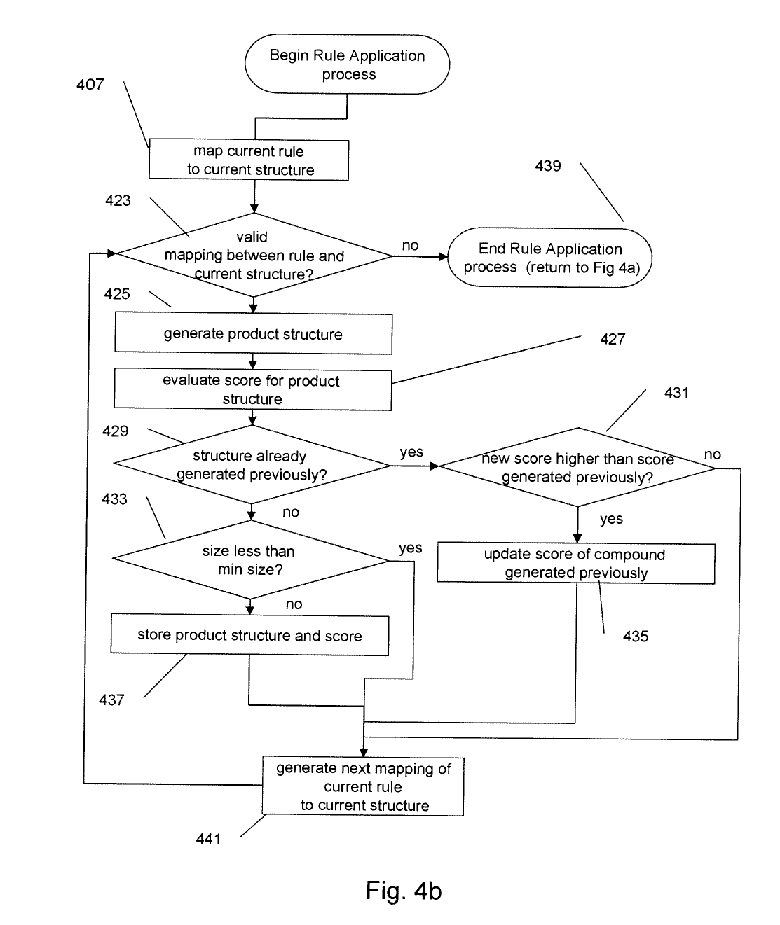

Referring to FIGS. 4a and 4b, the Apply Optimized Reaction Rule Set step [203] is further described. The first step 401 involves accepting the compound input by the user as the first current structure to be analyzed. The second step 405 involves loading the first rule in the Optimized Reaction Rule Set as the current rule to apply to the current structure. The next step 409 involves applying the current rule to the current structure. Step 409 is described in greater detail in relation to FIG. 4b. After the Optimized Reaction Rule Set application process has run, a tree containing the potential metabolites is extended with metabolites formed from the current structure according to the current rule, with their associated probability scores.

After step 409, decision box 411 determines if all of the rules in the Optimized Reaction Rule Set have been applied on the current structure. If not, the next rule is accepted as the current rule in step 413 and step 409 is repeated. If so, then the next step 415 is the determination if all of the structures have been analyzed.

While initially there is only one compound structure to be analyzed, each metabolite of that first compound structure is further susceptible to metabolic processes and could further result in additional metabolites. Thus, it is necessary to further process the metabolites, themselves, through the Optimized Reaction Rule Set. This further processing also will affect the probabilities and the ultimate ranking of the metabolite in the outcome listing. Obviously, this iterative process could expand infinitely so an arbitrary limitation is set by the system or by the user when defining the options as in FIG. 3b. In addition, other precautions are taken to ensure that the process does not become unwieldy due to the iterative steps. If all of the structures up to the maximum number of subsequent metabolic steps set in input field [317] have been analyzed, then the Apply Optimized Reaction Rule Set process terminates and the result is a listing of all the metabolites. Otherwise, steps 405-415 are repeated.

In step 419, the output list is first filtered by eliminating any results that do not meet the filter criteria set by the user as exemplified in FIG. 3b and then sorted to result in a ranked list of the potential metabolites. The end results are displayed in step 421 on the display means of the system.

Referring to FIG. 4b, the Optimized Reaction Rule Set application process is further described. In step 407, the current rule is mapped to the current structure. In decision box 423, the question is asked if the mapping process performed in steps 407 or 411 resulted in a valid mapping, i.e. if the current rule matches the current structure. If not, then the process is finished and returns back to step 411 of FIG. 4a. If there is a valid mapping of the current rule to the current structure, then a metabolite product structure is generated in step 425 and added to the potential metabolite list. When a single cleavage reaction results in multiple products, each product is treated as a separate metabolite. Metabolites generated via more than one route are represented by a single “node” linking to both branches of the metabolic network. This avoids duplication of metabolites as well as repetition of equivalent branches in the “metabolic tree”. This reduces the amount of time used in the iterative steps. Minor cleavage products consisting of only a small fraction of the parent (e.g. resulting from hydrolysis or dealkylation of small groups) are often considered not relevant. In one embodiment, small fragments are removed from the metabolic tree if they contain less then 15% of the atoms of the parent. This 15% cutoff was chosen based on the training set in which none of the experimental metabolites fell below this cutoff value. This cutoff also reduces the amount of iterative steps to be taken.

For that product structure, a product structure is evaluated to be assigned a given Calculated Probability. In general, the probability that has been assigned to the reaction rule that created the metabolite will be assigned as the Calculated Probability to that metabolite. However, if the resultant product structure is resulting from a structure that is a metabolite itself, the probability will depend on all steps leading from the parent structure to that resultant product structure. In one embodiment of the present invention the Calculated Probability of a multi step metabolite will be the product of the probabilities of the individual reaction rules that created it.

The next step 429 determines if the product structure is already listed in the list of metabolites. If it is, then the Calculated Probabilities for both structures are compared and the higher score is stored in steps 431 and 435. The score for the product structure already on the list is rewritten rather than adding a new entry onto the list in order to reduce the iterative steps taken. If the structure has not been previously generated it is stored to the list with its Calculated Probability in step 437. It is possible that there are several mappings of the current rule to the current structure. In step 441 the next such mapping is generated before processing is continued in step 423 iterating the mappings of the current rule to the current structure.

Referring to FIG. 5, the procedure for developing and optimizing the Reaction Rule Set is described. In general, the process of optimizing the reaction rule set ensures that the invented system is efficient and produces a list of metabolites that is useful, i.e. complete and ranked in order of decreasing likeliness. A non-ranked list that contains many unlikely potential metabolites is not practically useful. However, a list containing potential metabolites to a certain degree of completeness, i.e. including also less expected or minor metabolites, is likely to be quite long especially when multiple subsequent reactions are allowed. Therefore, an accurate ranking is required to identify in the list the metabolites most likely to be important. In order to achieve good ranking of the metabolites, optimization of the rules as described below is essential.

First, in step 501 a new general rule is defined. This general rule can be based on common knowledge, literature reports or experimental examples (in the training dataset, see. To facilitate the latter a “gap analysis” on the basis of reaction difference fingerprints were used to identify “missing rules”. The next step is to test the rule on an experimental data set. An example of an experimental data set would be MDL's Metabolite database. In each case, the data set can be tailored to eliminate reactions that are not pertinent to the Optimized Reaction Rule Set. For example, in working with the MDL Metabolite database, only data from studies in man were retrieved and reactions with “presumed” reactants or products were excluded. Reactions labeled to be an “optical resolution” which represent mostly experimental analysis rather than actual metabolic processes were also excluded. Furthermore, reactions with structures containing non-organic or non-existing elements, like —R or —X, were removed, as well as reactions involving large (non-drug-like) molecules, i.e. MW>900. The remaining dataset contained 6164 reactions observed with 1964 parent molecules. Reactions qualified “Major” in the database, based on at least one referenced publication, were labeled “Major” in the dataset as well. From the 6187 reactions the complete set of 3144 unique reactant structures was obtained, which was used for the optimization of the reaction rules.

The same procedure was followed for datasets of reactions observed in rat and reactions observed in in vitro studies using human and rat microsomes. Final evaluation of the method was performed with an independent test set, which was extracted from the update of the MDL Metabolite database to the 2006 version. For further evaluation purpose, a subset of cytochrome P450 (CYP) reactions was taken from this new data, i.e. reactions indicated to be metabolized by one or more CYP isoenzymes. The following table 1 provides an overview of the various datasets used.

TABLE 1
Overview of the different dataset retrieved from the
MDL Metabolite Database, 2001.

| | | Unique | |
|---|---|---|---|
| Dataset | Parents | reactants | Reactions |
| Human in vivo | 1921 | 3144 | 6187 |
| Human in vitro | 1148 | 1270 | 2189 |
| Rat in vivo | 3160 | 4966 | 9262 |
| Rat in vitro | 1849 | 2205 | 3806 |
| Human in vivo test- | 185 | 288 | 385 |
| set | | | |
| CYP test-set | 105 | 106 | 127 |

In the next step 503, each new rule is tested by applying it on all reactants, i.e. on all molecular centers matching the query, in the dataset. The resulting products were compared to the metabolites reported in the database for the individual reactants. The number of generated metabolites that match the experimentally observed metabolites in the database was divided by the total number of metabolites generated (which is equal to the number of molecular centers matching the query). This ratio provides a Rule Probability. The Rule Probability is defined as

$${p}_{rule} = \frac{number of experimental metabolites reproduced}{total number of metabolites generated}$$

The set of matched metabolic reactions were examined on the diversity of reacting atom centers and their direct chemical environment. Based on this examination, a rule was often further refined or split into multiple rules covering subsets of the experimental reactions with distinct reaction centers. Decision boxes 505, 509 and 511 are factors to determine if the rule needs to be further refined or split. For aliphatic reaction centers, for example, relevant distinctions can be made between reaction centers attached to aromatic, aliphatic or heteroatomic cores. For aromatic reaction centers, the presence of ortho, meta or para substituents may be queried to distinguish more or less activated sites.

Refinement also entails using a more restricted set of matching compounds, thereby reducing the number of incorrectly predicted metabolites and increasing the probability ratio. Division into multiple rules was used to account for differences in “reactivity” of different chemical groups towards the same reaction. Ultimately, if a resultant rule did not have a probability greater than a certain limit (0.01% in the embodiment shown in FIG. 5), then the rule was rejected.

One example of how the refinement process works is exemplified in FIG. 6. In the example on top, an initial rule for oxidation of an aliphatic primary alcohol is shown. Splitting of this rule creates two more specific rules. One rule for oxidation of an aliphatic primary alcohol is created, which matches 58 of the initial 85 experimental examples of primary alcohol oxidation in the training set. The second rule for oxidation of a benzylic primary alcohol covers a smaller number of experimental examples, however, with a significantly higher probability score than the rule for primary alcohol oxidation. The splitting of the initial rule clearly results in new rules that account for the higher susceptibility of benzylic alcohols towards oxidation compared to aliphatic alcohols. In general a refinement of the rule that results in at least one rule that has a higher probability creates a more efficient system that will produce more useful results.

Examples of rule refinements found with the above described method are, for example, for primary carbons that can be hydroxylated and subsequently further oxidized to carboxylate groups. The individual steps are incoded in the rule set, however, the probabilities for metabolites resulting from these steps were quite low. As the two-step oxidation of primary carbons to carboxylic acids are often represented as single metabolic reactions in the training dataset, rules for direct carboxylation of primary carbons were added. These rules showed significantly higher probabilities than would be obtained from applying the individual hydroxylation and oxidation steps. Note that since both the individual steps and the combined rules are included in the rule-set, the carboxylates can be formed via two different pathways. The method for predicting potential metabolites for a compound according to the invention now selects the path corresponding to the highest probability, which automatically selects the most appropriate rules.

Another case, which clearly illustrates how rules were refined, is the O-glucuronidation of primary oxygens. Here, four different rules were created, which reflected the observations that carboxyl oxygens are glucuronidated more frequently than hydroxyl oxygens and that both groups appeared to be more susceptible to glucuronidation when attached to aromatic cores than when they are attached to aliphatic groups. These differences in chemical environment will influence the nucleophilicity and acidity of the reacting oxygen centres. The effects on the observed frequencies can be understood, given the current knowledge that glucuronidation proceeds via a nucleophilic attack of the oxygen on UDP-glucuronic acid, and that the oxygen is activated through deprotonation by an active site base.

In similar ways, distinctions could be made between more and less reactive chemical subgroups for most of the different types of metabolic reactions covered in the SyGMa rules.

An important feature of the rule base is its completeness in terms of coverage of the reactions in the training dataset. Reaction fingerprints were used to analyze the contents of a reaction dataset. The fingerprints are used for clustering and visualization of the current training set, to analyze the coverage of the current rule base and to support the search for new rules.

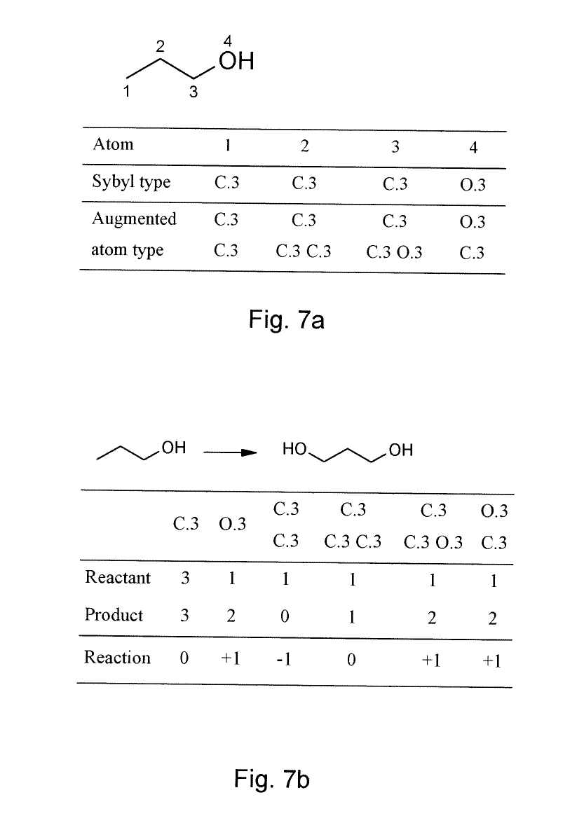

The reaction fingerprints that were applied describe the difference between the reactant and the product fingerprints and are based on an augmented atom description of the molecule. First, fingerprints were generated for reactant and product molecules separately, based on (non-augmented) Sybyl atom types and augmented atom descriptors, which are extended with a single layer of connected atoms around the central atom. For each descriptor ten bits are assigned. Thus, up to ten occurrences of an (augmented) atom type can be distinguished. Subsequently a difference fingerprint is defined in which the original bits are duplicated, one copy for the appearance and one for the disappearance of atom types. Atom types with equal counts in the reactant and product fingerprints vanish in the difference fingerprint. For example, FIG. 7a illustrates the (augmented) atom types used in this study for propanol and FIG. 7b illustrates the reaction fingerprint, representing the difference between the atomic fingerprints of reactant (1-propanol) and product (propane-1,3-diol). Based on the difference fingerprints, similarity coefficients such as Tanimoto similarity coefficient, can be calculated between pairs of reactions and subsequently be used for clustering or other types of analysis. Reactions which involve removal, addition or modification of defined molecular groups have very similar fingerprints. It should be noted, however, that other reactions, such as dealkylation, or hydrolysis, involve removal of non-specific parts of a molecule, which may result in more different fingerprints.

While building up the set of rules, the experimental reactions in the database were projected on a 2-dimensional plain using suitable methods such as SPE (stochastic proximity embedding) that keep the distances between points in the 2D scatter plot corresponding as much as possible with the calculated fingerprint distances. Thus, similar reactions cluster together in this visualization. Dots were colored according to SyGMa rule covering the metabolic reactions. As intended, reactions covered by the same rule clustered together in this visualization. From this coloring, clusters of reactions could be identified that were not yet covered by SyGMa. Based on this, new rules were added, or existing rules were extended to cover this identified new cluster of reactions. The fingerprint analysis, therefore, helps to identify gaps in the complete set of rules and helps to make the set of rules as complete as possible.

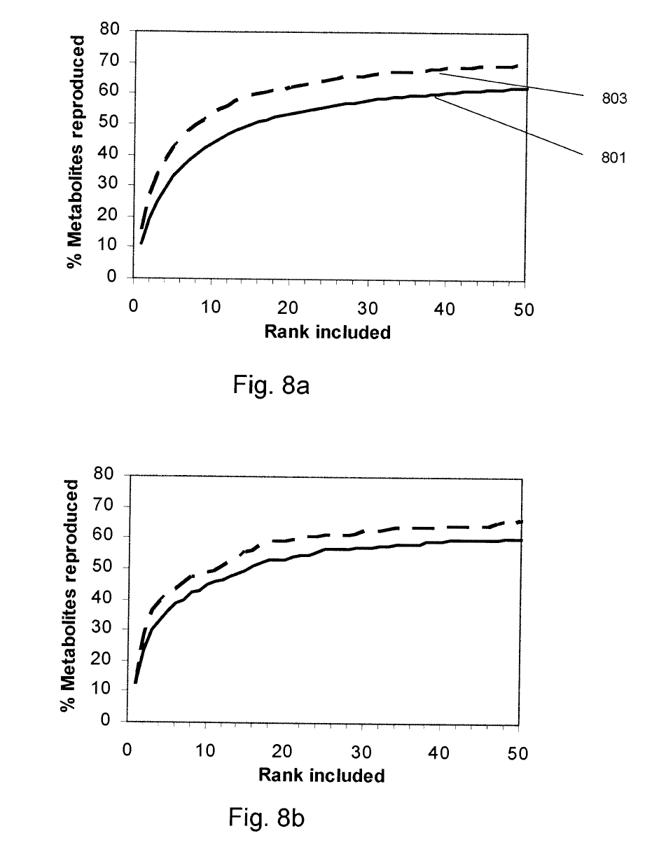

The overall performance of the rules was tested on the training set, as well as on the independent test set originating from a recent update of the MDL metabolite database. In total 71% of all metabolites in the training set are reproduced by the current set of rules. The fraction of major metabolites (metabolites that are qualified “Major” at least once based on the publications covered in the database) that is reproduced is even higher: 76%. These matches come from a large number of predicted metabolites generated by systematically applying all 144 rules on the parent compounds for up to 3 subsequent reaction steps. FIG. 8a indicates the fraction of all experimental metabolites in the training set that are reproduced as function of the number of metabolites from the top of the ranking list that are taken into account. 44% of all experimental metabolites are reproduced within the top 10 predicted metabolites (solid line 801). This includes 53% of the major metabolites (dashed line 803). The performance on the test set is very similar to the performance on the training set: 67% of the metabolites (69% of the major metabolites) are reproduced, 45% of the metabolites are ranked in the top 10 (FIG. 8b) including 49% of the major metabolites. The similarity in performance on the training data and test data indicates the robustness of the prediction method and the rule base.

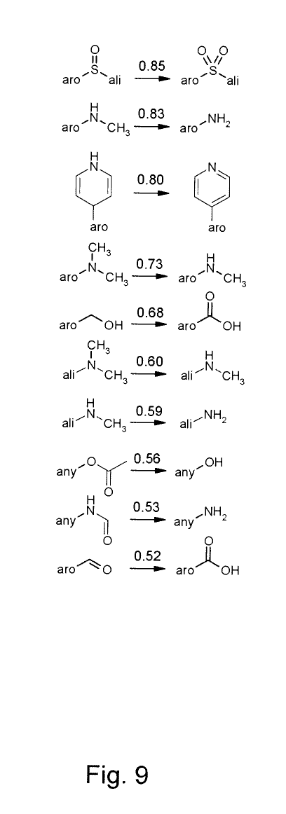

The calculated probability scores provide not only a means of ranking the in silico generated metabolites. They may also provide useful information to chemists looking for modification to improve metabolic behavior of their chemical series. To illustrate the information contained in the rules and their corresponding probabilities, FIG. 9 presents a top 10 of “most probable” reactions, i.e. rules most likely to generate true biotransformation metabolites when they apply to a chemical structure. Numbers given at the arrows are calculated probability factors. It is remarkable that the rules in this top 10 represent modifications of well defined small functional groups. They provide a practical list of chemical features to avoid in a search for metabolically stable compounds. On the other hand these most probable reactions can give useful indications to potential prodrugs that may be selectively metabolized in vivo into an active compound.

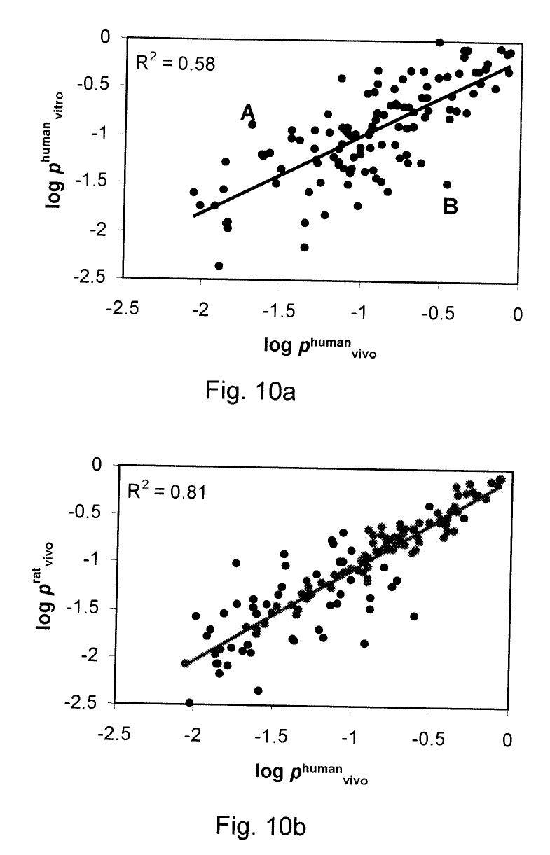

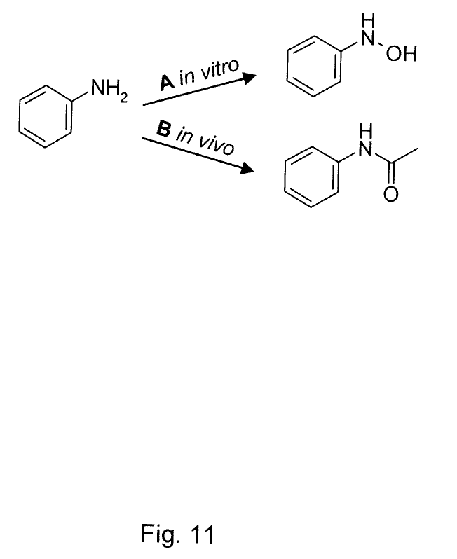

The probabilities calculated based on human in vivo data were compared to similar probabilities based on human in vitro data, rat in vivo data and rat in vitro data. FIG. 10a indicates that overall the probabilities obtained with human in vitro data correlate well with the probabilities based on the in vivo data. However, significant differences are present for some rules. Some of these differences can be rationalized on the basis of the experimental differences. For example, two “outliers” in FIG. 10a are identified to be N-acetylation (A) and N-hydroxylation (B) of aromatic amine groups, e.g. in anilines. These reactions are depicted in FIG. 11. N-acetylation (B) has a relatively high probability in vivo, while its probability in vitro is low. This can be explained by the fact that in vitro experiments (i.e. microsomal incubations) in general lack N-acetyl transferase activity. On the other hand, N-hydroxylation (A) has an intermediate probability in vitro, whereas its probability in vivo is low. Possibly, in the absence of the N-acetyl transferase activity N-hydroxylation becomes a more important metabolic route for aromatic amines in vitro.

FIG. 10b shows that the correlation between probability scores from human and rat in vivo data is significantly higher. This indicates that interspecies differences between human and rat metabolism, in terms of overall probabilities for different types of reactions, are smaller than differences between in vivo and in vitro results.

As a result of the above mentioned Reaction Rule Creation and Optimization process, the following set of Reaction Rules were developed and implemented in one embodiment of the present invention. This set is described with the following table 2: A set of SyGMa metabolic reaction rules for human in vivo drug metabolism. Note: in the chemical fragments specified below, uppercase C and N indicate aliphatic carbon and nitrogen, whereas lower case c and n indicate aromatic carbon and nitrogen. In the first column is the Reaction Rule.

-- N-dealkylation --
N-demethylation_R—NHCH3
N-demethylation_c-NHCH3
N-demethylation_R—N(CH3)2
N-demethylation_c-N(CH3)2
N-demethylation_R—N(CR)CH3
N-depropylation
N-deglycosidation
N-deformylation
N-dealkylation_piperazine
N-dealkylation_morpholine
N-dealkylation_R—NHCH2-alkyl
N-dealkylation_c-NHCH2-alkyl
N-dealkylation_tertiaryN—CH2-alkyl
N-dealkylation_quarternary
-- O-dealkylation --
O-demethylation
aliphatic_O-dealkylation
aromatic_O-dealkylation
O-deglycosidation
-- S-dealkylation --
S-dealkylation_c-SCH2—R
-- aromatic hydroxylation --
aromatic_hydroxylation_(para_to_carbon)
aromatic_hydroxylation_(para_to_nitrogen)
aromatic_hydroxylation_(para_to_oxygen)
aromatic_hydroxylation_(ortho_to_nitrogen)
aromatic_hydroxylation_(ortho_to_oxygen)
aromatic_hydroxylation_(ortho_to_2_substituents)
aromatic_hydroxylation_(aromatic_sulfur_containing_5ring)
-- aliphatic hydroxylation --
aliphatic_hydroxylation_(primary_carbon_next_to_quart_carbon)
aliphatic_hydroxylation_(primary_carbon_next_to_tert_carbon)
aliphatic_hydroxylation_(primary_carbon_next_to_secondary_carbon)
aliphatic_hydroxylation_(primary_carbon_next_to_SP2/SP1)
aliphatic_hydroxylation_(secondary_carbon,next_to_CH3)
aliphatic_hydroxylation_(secondary_carbon_in_a_ringA)
aliphatic_hydroxylation_(secondary_carbon_in_a_ringB)
aliphatic_hydroxylation_(secondary_carbon_next_to_SP2,not_in_a_ring)
aliphatic_hydroxylation_(secondary_carbon_next_to_SP2,in_a_ring)
aliphatic_hydroxylation_(secondary_carbon_both_sides_next_to_SP2,in_a_ring)
aliphatic_hydroxylation_(tertiary_carbon_next_to_SP2
aliphatic_hydroxylation_(tertiary_carbon_linked_to_two_CH3_groups)
-- benzylic hydroxylation --
benzylic_hydroxylation_(c-CH3)
benzylic_hydroxylation_(c-CH2—CR)
benzylic_hydroxylation_(c-CH2—N)
benzylic_hydroxylation_(c-CH1)
-- reduction --
carbonyl_reduction_(aliphatic)
carbonyl_reduction_(next_to_SP2_carbon)
carbonyl_reduction_(next_to_aromatic_carbon)
carbonyl_reduction_(both_sides_next_to_aromatic_carbon)
aldehyde_reduction_(aliphatic)
aldehyde_reduction_(aromatic)
double_bond_reduction
-- aldehyde oxidation --
aldehyde_oxidation_(aliphatic)
aldehyde_oxidation_(aromatic)
-- methylation --
methylation_(aromatic_OH)
methylation_(thiol)
-- O-deacetylation --
O-deacetylation
-- N-deacetylation --
N-deacetylation
-- carboxylation --
carboxylation_(primary_carbon_next_to_quart_carbon)
carboxylation_(primary_carbon_next_to_tert_carbon)
carboxylation_(primary_carbon_next_to_secondary_carbon)
carboxylation_(primary_carbon_next_to_SP2)
carboxylation_(benzylic_CH3)
-- decarboxylation --
Decarboxylation
beta-oxidation
-- dehydrogenation --
dehydrogenation_(alpha,beta_to_carbonyl)
dehydrogenation_(C—CH3->C═CH2)
dehydrogenation_(amine)
dehydrogenation_(aromatization_of_1,4-dihydropyridine)
-- primary alcohol oxidation to carboxyl --
primary_alcohol_oxidation_(benzylic)
primary_alcohol_oxidation_(aliphatic)
-- secondary alcohol oxidation to carbonyl --
secondary_alcohol_oxidation_(aliphatic)
secondary_alcohol_oxidation_(benzylic)
-- S oxidation --
sulfoxide_oxidation_(c-S-c)
sulfoxide_oxidation_(C—S—C)
sulfoxide_oxidation_(C—S-c)
sulfide_oxidation_(c-S—C)
sulfide_oxidation_(C—S—C)
sulfide_oxidation_(c-S-c)
sulfoxide_reduction
-- epoxide_hydrolysis --
epoxide_hydrolysis
-- oxidative_deamination --
oxidative_deamination_(on_secondary_carbon)
oxidative_deamination_(on_primary_carbon)
oxidative_deamination_(amidine)
-- nitro --
nitro_to_aniline
aniline_to_nitro
-- dehalogenation --
aliphatic_dehalogenation
aromatic_dechlorination
-- ring_closure --
ring_closure_(hydroxyl-5bonds-carboxyl)
ring_closure_(hydroxyl-6bonds-carboxyl)
ring_closure_(NH1-5bonds-carboxyl)
ring_closure_(NH1-6bonds-carboxyl)
-- hydrolysis --
hydrolysis_(methoxyester)
hydrolysis_(ester)
hydrolysis_(primary_amide)
hydrolysis_(secondary_amide)
hydrolysis_(tertiary_amide)
hydrolysis_(heteroatom_bonded_amide)
hydrolysis_(urea/carbonate)
hydrolysis_(X = X-X_exclude_phosphate)
hydrolysis_(CNC(OH)R)
hydrolysis_(N-substituted-pyridine)
acetyl_shift
-- tautomerisation --
tautomerisation_(keto->enol)
-- special rules --
vinyl_oxidation
isopropenyl_oxidation
oxidation_(amine_in_a_ring)
imine_hydrolysis
hydrazone_hydrolysis
diazene_cleavage
azide_cleavage
aromatic_oxidation
phosphine_sulphide_hydrolysis
oxidation_to_quinone
cyclic_hemiacetal_ring_opening
imine_oxidation
-- O-glucuronidation --
O-glucuronidation_(aliphatic_hydroxyl)
O-glucuronidation_(aromatic_hydroxyl)
O-glucuronidation_(aliphatic_carboxyl)
O-glucuronidation_(aromatic_carboxyl)
-- N-glucuronidation --
N-glucuronidation_(aniline)
N-glucuronidation_(aliphatic_NH2)
N-glucuronidation_(aniline_NH1-R)
N-glucuronidation_(N(CH3)2)
N-glucuronidation_(NCH3_in_a_ring)
N-glucuronidation_(NH_in_a_ring)
N_glucuronidation_(aromatic_=n-)
N_glucuronidation_(aromatic_-nH-)
-- N-oxidation --
N-oxidation_(tertiary_N)
N-oxidation_(tertiary_NCH3)
N-oxidation_(RN(CH3)2)
N-oxidation_(—N═)
N-oxidation_(aniline)
-- sulfation --
sulfation_(aromatic_hydroxyl)
sulfation_(aniline)
-- N-acetylation --
N-acetylation_(aniline)
N-acetylation_(aliphatic_NH2)
N-acetylation_(heteroatom_bonded_NH2)
N-acetylation_(NH1)
N-acetylation_(NH1—CH3)
-- glycination --
glycination_(aromatic_carboxyl)
glycination_(aliphatic_carboxyl)
-- phosphorylation --
Phosphorylation
Dephosphorylation

There are relatively many different rules for N-dealkylation (i.e. 16), with probabilities ranging from 0.04 (N-dealkylation of piperazine) to 0.83 (N-demethylation of methylamine attached to aromatic carbon). The probabilities show internal consistency in that amines connected to aromatic carbons are always more likely to dealkylate than amines attached to aliphatic groups only.

There are relatively many different rules for hydroxylation of alipatic carbons (i.e. 12), with probabilities ranging from 0.014 (tertiary carbon, which should be attached to an sp2 hybridised atom) to 0.43 (secondary carbon in a ring attached to sp2 hybridised atoms on both sides). This division of aliphatic hydroxylation into a large number of specific rules acting on aliphatic carbons in different environments results in much more refined predictions and significantly reduces the number of false predictions than would have been achieved without this distinction of different rules for aliphatic hydroxylation.

The rule set includes quite special rules, like ring-forming condensation reactions, beta-oxidation of aliphatic carboxylic acids, glycination, phosphorylation and specific reactions applicable to steroids. It also includes some rules for dehydrogenations which result in extension of a conjugated system in a molecule. These rules exemplify the ability of SyGMa and its methods of improvement to come up with predictions that also people with knowledge in the field would not expect/think of immediately/easily.

There are therefore a large number of embodiments of the present invention, which are characterized by the use of a particular reaction in the set of reaction rules, which have in particular enhanced the usefulness of the method of metabolite prediction and identification. Such rules are for example the group of 16 different rules for N-dealkylation; the separate rules for N-dealkylation of amines either connected to aromatic carbons or to aliphatic groups only; the presence of a number, in particular 12, of different rules for hydroxylation of alipatic carbons, one of those for a tertiary carbon, which should be attached to an sp2 hybridised atom and one rule for a secondary carbon in a ring attached to sp2 hybridised atoms on both sides; the rule for ring-forming condensation reactions; the rule for beta-oxidation of aliphatic carboxylic acids; the rule for glycination; the rule for phosphorylation; the rules for specific reactions applicable to steroids and the rules for dehydrogenations which result in extension of a conjugated system in a molecule. Thus, each rule described in the table of rules above and the table of rules in the example illustrate also separate embodiments of the invention. In particular each of those rules with substantial probability scores, for example above 0.7, 0.6, 0.5, 0.4, 0.3, 0.2 or 0.1 can be used to characterize any embodiment of the invention. Those reaction rules also as subsets are characteristic for embodiments of the invention, such as a set of reaction rules characterized by the presence of a subset of rules comprising all rules in the table above and in the example with probabilities above 0.7, 0.6, 0.5, 0.4, 0.3, 0.2 or 0.1.

The invented method can be implemented with focus on a set of reaction rules comprising a set of at least 10 different rules for hydroxylation, whereby with those rules at least two or more distinctions in hydroxylations out of the following list are made:

a) a distinction in aromatic, aliphatic and benzylic hydroxylation;
b) a distinction in aromatic hydroxylation of 5- and 6-membered aromatic rings;
c) a distinction in aromatic hydroxylation of aromatic carbon atoms positioned para, meta or ortho to non-hydrogen substituents;
d) a distinction in aromatic hydroxylation between aromatic carbon atoms positioned meta to non-hydrogen substituents and said aromatic carbon atoms being at the same time 1) either positioned ortho or para to another non-hydrogen substituent or 2) positioned ortho or para to a hydrogen atom;
e) a distinction in aromatic hydroxylation between aromatic carbons atoms positioned ortho to non-hydrogen substituents and said aromatic carbon atoms being at the same time a) either positioned meta or para to another non-hydrogen substituent or b) positioned meta or para to a hydrogen atom;
f) a distinction in aromatic hydroxylation of substituents connected to the aromatic system via a carbon, oxygen, nitrogen or any non-hydrogen atom;
g) a distinction in aromatic hydroxylation of nitrogen and sulfur containing 5-membered aromatic rings;
h) a distinction in hydroxylation of primary, secondary or tertiary aliphatic carbon atoms;
i) a distinction in hydroxylation of aliphatic carbon atoms connected to heteroatoms or carbon atoms;
j) a distinction in hydroxylation of aliphatic carbon atoms connected to aromatic carbon atoms, conjugated non-aromatic atoms, or aliphatic carbon atoms;
k) a distinction in hydroxylation of aliphatic carbon atoms connected to methyl groups or secondary, tertiary or quaternary carbon atoms;
l) a distinction in hydroxylation of aliphatic carbon atoms connected to atoms which are connected to methyl groups, heteroatoms, conjugated carbon atoms or aromatic carbon atoms;
m) a distinction in hydroxylation of aliphatic carbon atoms which are part of a ring and those which are not part of a ring.

The invented method can also be implemented with focus on a set of reaction rules comprising at least 10 rules for hydroxylation and at least one of those rules is selected out of the following list:

a) a rule for hydroxylation of an aromatic carbon in a 6-membered ring positioned para to another carbon;
b) a rule for hydroxylation of an aromatic carbon in a 6-membered ring positioned para to a nitrogen;
c) a rule for hydroxylation of an aromatic carbon in a 6-membered ring positioned para to an oxygen;
d) a rule for hydroxylation of an aromatic carbon in a 6-membered ring positioned meta to a carbon and not positioned para to a non-hydrogen atom;
e) a rule for hydroxylation of an aromatic carbon in a 6-membered ring positioned ortho to a carbon and not positioned para and/or ortho to a non-hydrogen atom;
f) a rule for hydroxylation of an aromatic carbon in a 6-membered ring positioned ortho to a nitrogen and not positioned para to a non-hydrogen atom;
g) a rule for hydroxylation of an aromatic carbon in a 6-membered ring positioned ortho to an oxygen and not positioned para to a non-hydrogen atom;
h) a rule for hydroxylation of an aromatic carbon in a 6-membered ring positioned ortho to two non-hydrogen substituents, one of which needs to be carbon, oxygen or nitrogen;
i) a rule for hydroxylation of an aromatic carbon atom in 5-membered ring connected to a sulfur in said ring;
j) a rule for hydroxylation of an aromatic carbon atom in 5-membered ring connected to a nitrogen in said ring;
k) a rule for hydroxylation of a primary aliphatic carbon connected to a quaternary carbon which is connected to at least one heteroatom;
l) a rule for hydroxylation of a primary aliphatic carbon connected to a tertiary carbon which is connected to at least methyl group;
m) a rule for hydroxylation of a primary aliphatic carbon connected to a secondary carbon;
n) a rule for hydroxylation of a primary aliphatic carbon connected to a carbon which is connected by either a double or a triple bond to yet another atom;
o) a rule for hydroxylation of a secondary aliphatic carbon connected to a methyl group and another tetravalent carbon;
p) a rule for hydroxylation of a secondary aliphatic ring carbon connected to two secondary carbons;
q) a rule for hydroxylation of a secondary aliphatic ring carbon connected to a secondary carbon and another tetravalent non-secondary carbon which is connected to either a methyl group or a heteroatom;
r) a rule for hydroxylation of a secondary aliphatic non-ring, non-benzylic carbon connected to a tetravalent carbon and another atom which is connected by a double bond to yet another atom;
s) a rule for hydroxylation of a secondary aliphatic non-benzylic ring carbon connected to a tetravalent carbon and another atom which is either a nitrogen or connected by a double bond to yet another atom;
t) a rule for hydroxylation of a secondary aliphatic non-benzylic ring carbon connected to two atoms which are connected by a double bond to yet another atom;
u) a rule for hydroxylation of a tertiary carbon connected to two aliphatic carbons, one of which is connected to either a nitrogen atom or a carbon atom connected by a double bond to yet another atom;
v) a rule for hydroxylation of a non-benzylic tertiary carbon connected to two methyl groups;
w) a rule for hydroxylation of a benzylic methyl group.

### EXAMPLE

In this example (Table 3) the rules as presented in Table 2 are presented again with specified probability scores (second column) based on human in vivo data with the format for data input using Daylight SMIRKS language in column three. In the fourth column is the number of correctly predicted metabolic products and the total number of generated metabolic products. From this it can be affirmed that the rules with the highest probabilities include mostly modifications of well defined small functional groups as shown in FIG. 9.

TABLE 3

| NAME | probability | SMIRKS | Metabs/occurrence |
|---|---|---|---|
| ## --- Phase 1 reactions --- ## | | | |
| # -- N-dealkylation -- | | | |
| N-demethylation_(R—NHCH3) | 0.586 | [*;!c:1][NH1;X3:2][CH3]>>[*:1][N:2] | # 65/111 |
| N-demethylation_(c-NHCH3) | 0.833 | [c:1][NH1;X3:2][CH3]>>[c:1][N:2] | # 10/12 |
| N-demethylation_(R—N(CH3)2) | 0.600 | [*;!c:1][NH0;X3:2]([CH3])[CH3:3]>>[*:1][N:2][CH3:3] | # 90/150 |
| N-demethylation_(c-N(CH3)2) | 0.733 | [c:1][NH0;X3:2]([CH3])[CH3:3]>>[c:1][N:2][CH3:3] | # 11/15 |
| N-demethylation_(R—N(CR)CH3) | 0.408 | [*;!$([CH3]):1][NH0;X3:2]([CH3])[#6;!$([CH3]):3]>>[*:1][N:2][#6:3] | # 146/358 |
| N-demethylation_(nCH3) | 0.086 | [n:1][CH3]>>[n:1] | # 3/35 |
| N-depropylation | 0.339 | [N;X3:2][CH1]([CH3])[CH3]>>[N:2] | # 20/59 |
| N-deglycosidation | 0.250 | [NX3:2][C:3]1[O:4][C:5][C:6][C:7]1>>[N:2]•O[C:3]1[O:4][C:5][C:6][C:7]1 | # 10/40 |
| N-deformylation | 0.533 | [NX3:2][CX3;H1]=O>>[N:2] | # 8/15 |
| N-dealkylation_(piperazine) | 0.034 | [*;!C,!X4:1][N;X3:2]1[C:3][C:4][N;X3:5][CH2][CH2]1>>[*:1][N:2][C:3][C:4] | # 4/117 |
| | | [N:5] | |
| N-dealkylation_(morpholine) | 0.119 | [N;X3:2]1[C:3][C:4][O:5][CH2][CH2]1>>[N:2][C:3][C:4][O:5] | # 5/42 |
| N-dealkylation_(R—NHCH2-alkyl) | 0.098 | [*;!c:1][NH1;X3:2]!@[CH2:3][#6:4]>>[*:1][N:2]•O[C:3][#6:4] | # 71/728 |
| N-dealkylation_(c-NHCH2-alkyl) | 0.203 | [c:1][NH1;X3:2]!@[CH2:3][#6:4]>>[c:1][N:2]•O[C:3][#6:4] | # 13/64 |
| N-dealkylation_(tertiaryN—CH2- | 0.139 | [NH0;X3:2]!@[C;X4;H2:4]>>[N:2]•O[C:4] | # |
| alkyl) | | | 194/1394 |
| N-dealkylation_(quarternary_N) | 0.129 | [#6:1][N+;X4:2]([#6:3])([CH3:4])!@[#6;H1,H2:5]>>[#6:1][N:2]([#6:3])[C:4] | # 4/31 |
| | | •O[#6:5] | |
| N-dealkylation_(nCH2) | 0.052 | [n:1][CH2:2]>>[n:1]•O[C:2] | # 13/249 |
| # -- O-dealkylation -- | | | |
| O-demethylation | 0.300 | [#6;!$(C═O):1][O:2][CH3]>>[#6:1][O:2] | # 152/506 |
| O-dealkylation_(aliphatic) | 0.125 | [C;!$(C(O)~[!#6]);!$([CH3]):1][O;!$(O1CC1):2][C;X4;!$(C(O)~[!#6]);H1,H2:3] | # 23/184 |
| | | >>[C:1][O:2]•O[C:3] | |
| O-dealkylation_(aromatic) | 0.082 | [c:1][O:2][C;X4;!$(C(O)~[!#6]);H1,H2:3]>>[c:1][O:2]•O[C:3] | # 38/463 |
| O-deglycosidation | 0.176 | [#6;!$([CH3]);!$(C═O):1][O:2][C:3]1[O:4][C:5][C:6][C:7][C:8]1>>[#6:1][O:2] | # 55/313 |
| | | •O[C:3]1[O:4][C:5][C:6][C:7][C:8]1 | |
| O- | 0.500 | [O:1]1[c:2]2[c:3][c:4][c:5][c:6][c:7]2[O:8][CH2]1>>[O:1][c:2]2[c:3][c:4][c:5] | # 9/18 |
| dealkylation_(methylenedioxyphenyl)a | | [c:6][c:7]2[O:8] | |
| O- | 0.194 | [O:1]1[c:2]2[c:3][c:4][c:5][c:6][c:7]2[O:8][CH2:9]1>>[O:1]1[c:2]2[c:3][c:4] | # 7/36 |
| dealkylation_(methylenedioxyphenyl)b | | [c:5][c:6][c:7]2[O:8]•[CH2:9]1 | |
| # -- S-dealkylation -- | | | |
| S-dealkylation_c-SCH2—R | 0.053 | [c:1][S:2][CH2:3]>>[c:1][S:2]•O[C:3] | # 4/76 |
| # -- aromatic hydroxylation -- | | | |
| aromatic_hydroxylation_(para_to_carbon) | 0.073 | [#6:1][a:2]1[a:3][a:4][cH1:5][a:6][a:7]1>>[#6:1][a:2]1[a:3][a:4][c:5](O)[a:6] | # |
| | | [a:7]1 | 149/2042 |
| aromatic_hydroxylation_(para_to_nitrogen) | 0.167 | [#7:1][a:2]1[a:3][a:4][cH1:5][a:6][a:7]1>>[#7:1][a:2]1[a:3][a:4][c:5](O)[a:6] | # 132/791 |
| | | [a:7]1 | |
| aromatic_hydroxylation_(para_to_oxygen) | 0.085 | [#8:1][a:2]1[a:3][a:4][cH1:5][a:6][a:7]1>>[#8:1][a:2]1[a:3][a:4][c:5](O)[a:6] | # 53/622 |
| | | [a:7]1 | |
| aromatic_hydroxylation_(meta_to_carbon) | 0.015 | [#6:1][a:2]1[a;!$([cH0]):3][cH1:4][a;!$([cH0]):5][a:6][a;!$([cH0]):7]1>>[#6:1] | # 10/685 |
| | | [a:2]1[a:3][c:4](O)[a:5][a:6][a:7]1 | |
| aromatic_hydroxylation_(ortho_to_carbon) | 0.009 | [#6:1][a:2]1[cH1:3][a;!$([cH0]):4][a:5][a;!$([cH0]):6][a:7]1>>[#6:1][a:2]1[c:3] | # 17/1914 |
| | | (O)[a:4][a:5][a:6][a:7]1 | |
| aromatic_hydroxylation_(ortho_to_nitrogen) | 0.031 | [#7:1][a:2]1[cH1:3][a;!$([cH0]):4][a:5][a;!$([cH0]):6][a:7]1>>[#7:1][a:2]1[c:3] | # 26/837 |
| | | (O)[a:4][a:5][a:6][a:7]1 | |
| aromatic_hydroxylation_(ortho_to_oxygen) | 0.041 | [#8:1][a:2]1[cH1:3][a;!$([cH0]):4][a:5][a;!$([cH0]):6][a:7]1>>[#8:1][a:2]1[c:3] | # 23/558 |
| | | (O)[a:4][a:5][a:6][a:7]1 | |
| aromatic_hydroxylation_(ortho_to_2_substituents) | 0.014 | [#6,#7,#8:1][a:2]1[cH1:3][cH0:4][a:5][a;!$([cH0]):6][a:7]1>>[#6,#7,#8:1] | # 13/951 |
| | | [a:2]1[c:3](O)[c:4][a:5][a:6][a:7]1 | |
| aromatic_hydroxylation_(sulfur_containing_5ring) | 0.067 | [cH1;$(c1saaa1):2]>>[c:2]O | # 3/45 |
| aromatic_oxidation_(nitrogen_containing_5ring) | 0.123 | [n:1]=[cH1;$(c1naaa1):2]>>[n:1]-[c:2]=O | # 19/154 |
| # -- aliphatic hydroxylation -- | | | |
| aliphatic_hydroxylation_(primary_carbon_next_to_quart_carbon) | 0.051 | [C;X4;H0;$(C[!C]):1][CH3:2]>>[C:1][C:2]O | # 15/296 |
| aliphatic_hydroxylation_(primary_carbon_next_to_tert_carbon) | 0.024 | [CH1;$(C(-[#6])(-[#6])-[CH3]):1][CH3:2]>>[C:1][C:2]O | # 10/424 |
| aliphatic_hydroxylation_(primary_carbon_next_to_sec_carbon) | 0.073 | [#6:1][CH2:2][CH3:3]>>[#6:1][C:2][C:3]O | # 32/441 |
| aliphatic_hydroxylation_(primary_carbon_next_to_SP2_or_SP1) | 0.053 | [C;$(C=*),$(C#*):1][CH3:2]>>[C:1][C:2]O | # 23/434 |
| aliphatic_hydroxylation_(sec_carbon, | 0.114 | [CX4:1][CH2:2][CH3]>>[C:1][C:2](O)C | # 41/359 |
| next_to_CH3) | | | |
| aliphatic_hydroxylation_(sec_carbon_in_a_ringA) | 0.112 | [CX4;H2:1][CH2;R:2][CX4;H2:3]>>[C:1][C:2](O)[C:3] | # 59/525 |
| aliphatic_hydroxylation_(sec_carbon_in_a_ringB) | 0.029 | [CX4;H2:1][CH2;R:2][CX4;!H2:3][*;$([CH3]),!#6:4]>>[C:1][C:2](O)[C:3][*:4] | # 28/970 |
| aliphatic_hydroxylation_(sec_carbon_next_to_SP2, | 0.012 | [CX4:1][CH2;!R:2][*;!c;$(*=*):3]>>[C:1][C:2](O)[*:3] | # 6/499 |
| not_in_a_ring) | | | |
| aliphatic_hydroxylation_(sec_carbon_next_to_SP2, | 0.051 | [CX4:1][CH2;R:2][*;!c;$(*=*),$([#7]):3]>>[C:1][C:2](O)[*:3] | # 81/1588 |
| in_a_ring) | | | |
| aliphatic_hydroxylation_(sec_carbon_both_sides_next_to_SP2, | 0.432 | [*;!c;$(*=*):1][CH2;R:2][*;!c;$(*=*):3]>>[*:1][C:2](O)[*:3] | # 16/37 |
| in_a_ring) | | | |
| aliphatic_hydroxylation_(tert_carbon_next_to_SP2 | 0.015 | [C:1][CH1;X4:2]([C;!$([CH3]):3])[N,C&$([C]=*):4]>>[C:1][C:2](O)([C:3]) | # 14/958 |
| | | [N,C:4] | |
| aliphatic_hydroxylation_(tert_carbon_linked_to_two_CH3_groups) | 0.089 | [CH3][CH1;X4;!$(Cc):1][CH3]>>C[C:1](O)C | # 16/179 |
| # -- benzylic hydroxylation -- | | | |
| benzylic_hydroxylation_(c-CH3) | 0.163 | [c:1][CH3:2]>>[c:1][C:2]O | # 55/338 |
| benzylic_hydroxylation_(c-CH2- | 0.076 | [c:1][CH2:2][#6:3]>>[c:1][C:2](O)[#6:3] | # 59/774 |
| CR) | | | |
| benzylic_hydroxylation_(c-CH2—N) | 0.081 | [c:1][CH2:2][NH0:3]>>[c:1][C:2](O)[N:3] | # 9/111 |
| benzylic_hydroxylation_(c-CH1) | 0.071 | [c:1][CH1;X4;!$(C[O,N]):2][#6;$([CH3]),$(C═*):3]>>[c:1][C:2](O)[#6:3] | # 9/126 |
| # -- reduction -- | | | |
| carbonyl_reduction_(aliphatic) | 0.389 | [C;X4:1][C:2](=[O:3])[C;X4:4]>>[C:1][C:2](-[O:3])[C:4] | # 95/244 |
| carbonyl_reduction_(next_to_SP2_carbon) | 0.114 | [C;X3:1][C:2](=[O:3])[C;X4:4]>>[C:1][C:2](-[O:3])[C:4] | # 12/105 |
| carbonyl_reduction_(next_to_aromatic_carbon) | 0.370 | [c:1][C:2](=[O:3])[C;X4:4]>>[c:1][C:2](-[O:3])[C:4] | # 27/73 |
| carbonyl_reduction_(both_sides_next_to_aromatic_carbon) | 0.036 | [c:1][C:2](=[O:3])[c:4]>>[c:1][C:2](-[O:3])[c:4] | # 4/110 |
| aldehyde_reduction | 0.152 | [#6:1][CH1:2]=[O:3]>>[#6:1][C:2]-[O:3] | # 5/33 |
| double_bond_reduction | 0.084 | [C;$(C[OH1]),$(C═O):1][C:2]=[C:3]>>[C:1][C:2]-[C:3] | # 53/630 |
| # -- aldehyde oxidation -- | | | |
| aldehyde_oxidation | 0.515 | [#6:1][CH1:2]=[O:3]>>[#6:1][C:2](O)=[O:3] | # 17/33 |
| # -- O-deacetylation -- | | | |
| O-deacetylation | 0.557 | [#6:1][O:2]C(═O)[CH3]>>[#6:1][O:2] | # 54/97 |
| # -- N-deacetylation -- | | | |
| N-deacetylation | 0.169 | [N:2]C(═O)[CH3]>>[N:2] | # 10/59 |
| # -- carboxylation - | | | |
| carboxylation_(primary_carbon_next_to_quart_carbon) | 0.014 | [C;X4;H0;$(C[!C]):1][CH3:2]>>[C:1][C:2](═O)O | # 4/296 |
| carboxylation_(primary_carbon_next_to_tert_carbon) | 0.017 | [CH1;$(C(-[#6])(-[#6])-[CH3]):1][CH3:2]>>[C:1][C:2](═O)O | # 7/424 |
| carboxylation_(primary_carbon_next_to_sec_carbon) | 0.025 | [#6:1][CH2:2][CH3:3]>>[#6:1][C:2][C:3](═O)O | # 11/441 |
| carboxylation_(primary_carbon_next_to_SP2) | 0.023 | [C;$(C═*),$(C#*):1][CH3:2]>>[C:1][C:2](═O)O | # 10/434 |
| carboxylation_(benzylic_CH3) | 0.044 | [c:1][CH3:2]>>[c:1][C:2](═O)O | # 15/338 |
| # -- decarboxylation -- | | | |
| decarboxylation | 0.025 | [*;!C:1][#6:2]C(═O)[OH1]>>[*:1][#6:2] | # 11/437 |
| beta-oxidation | 0.150 | [CH2:1][CH2]C(═O)[OH1]>>[C:1](═O)O | # 16/107 |
| # -- dehydrogenation -- | | | |
| dehydrogenation_(alpha,beta_to_SP2_both_sides) | 0.055 | [*;$([#6&X3]),$([#7]~[#6X3]):1][CX4;H1&!$(C- | # 12/217 |
| | | [!#6]),H2:2][CX4;H2:3][*;$([#6&X3]),$([#7]~[#6X3]):4]>>[*:1][C:2]=[C:3][*:4] | |
| dehydrogenation_(C—CH3->C═CH2) | 0.025 | [#6;$([#6]=[#6]),$([CH1](C)(C)C):1][C;H1&!$(C- | # 5/202 |
| | | [!#6]),H2:2][CH3:3]>>[C:1][C:2]=[C:3] | |
| dehydrogenation_(amine) | 0.179 | [N,c:1][C;X4;H1:2]-[N;X3;H1:3]>>[N,c:1][C:2]=[N:3] | # 5/28 |
| dehydrogenation_(aromatization_of_1,4- | 0.800 | [c:1][#6:2]1[#6:3]=[#6:4][NH1:5][#6:6]=[#6:7]1>>[c:1][#6:2]1=[#6:3][#6:4]= | # 20/25 |
| dihydropyridine) | | [N:5][#6:6]=[#6:7]1 | |
| # -- primary alcohol oxidation to carboxyl -- | | | |
| primary_alcohol_oxidation_(benzylic) | 0.675 | [c:1][CH2:2][OH1]>>[c:1][C:2](═O)O | # 27/40 |
| primary_alcohol_oxidation_(aliphatic) | 0.198 | [C:1][CH2:2][OH1]>>[C:1][C:2](═O)O | # 58/293 |
| # -- secondary alcohol oxidation to carbonyl -- | | | |
| secondary_alcohol_oxidation_(aliphatic) | 0.098 | [C;!$(C[OH1]):1][CH1:2]([C;!$(C[OH1]):3])- | # 58/594 |
| | | [OH1:4]>>[C:1][C:2]([C:3])=[O:4] | |
| secondary_alcohol_oxidation_(benzylic) | 0.124 | [c:1][CH1:2]([C:3])-[OH1:4]>>[c:1][C:2]([C:3])=[O:4] | # 13/105 |
| # -- S oxidation -- | | | |
| sulfoxide_oxidation_(c-S—C) | 0.850 | [c:1][S;X3:2](=[O:3])[C:4]>>[c:1][S:2](=[O:3])(═O)[C:4] | # 17/20 |
| sulfoxide_oxidation_(C—S—C) | 0.450 | [C:1][S;X3:2](=[O:3])[C:4]>>[C:1][S:2](=[O:3])(═O)[C:4] | # 9/20 |
| sulfoxide_oxidation_(c-S-c) | 0.125 | [c:1][S;X3:2](=[O:3])[c:4]>>[c:1][S:2](=[O:3])(═O)[c:4] | # 2/16 |
| sulfide_oxidation_(c-S—C) | 0.180 | [c:1][S;X2:2][C:4]>>[c:1][S:2](═O)[C:4] | # 9/50 |
| sulfide_oxidation_(C—S—C) | 0.211 | [C:1][S;X2:2][C:4]>>[C:1][S:2](═O)[C:4] | # 31/147 |
| sulfide_oxidation_(c-S-c) | 0.263 | [c:1][#16;X2:2][c:4]>>[c:1][#16:2](═O)[c:4] | # 35/133 |
| sulfoxide_reduction | 0.196 | [S;X3;$(S([#6])[#6]):1]═O>>[S:1] | # 11/56 |
| # -- epoxide_hydrolysis -- | | | |
| epoxide_hydrolysis | 0.429 | [C:1]1O[C:2]1>>[C:1](O)[C:2]O | # 9/21 |
| # --oxidative_deamination -- | | | |
| oxidative_deamination_(on_secondary_carbon) | 0.120 | [C:1][CH1:2]([C:3])[NH2]>>[C:1][C:2]([C:3])═O | # 12/100 |
| oxidative_deamination_(on_primary_carbon) | 0.043 | [C:1][CH2:2][NH2]>>[C:1][C:2]═O | # 2/47 |
| oxidative_deamination_(amidine) | 0.191 | [#6:1][N:2]=;@[C:3]([#6:4])[N:5]>>[#6:1][N:2]-[C:3]([#6:4])═O•[N:5] | # 9/47 |
| # -- nitro -- | | | |
| nitro_to_aniline | 0.135 | [c:1][N+](═O)[O—]>>[c:1][NH2] | # 12/89 |
| aniline_to_nitro | 0.033 | [c;$(c1[cH1][cH1][c]([*;!#1])[cH1][cH1]1):1][NH2]>>[c:1][N+](═O)[O—] | # 2/60 |
| # -- dehalogenation -- | | | |
| aliphatic_dehalogenation | 0.130 | [CX4;H1,H2:1][Cl,Br,l]>>[C:1]O | # 9/69 |
| aromatic_dechlorination | 0.043 | [c;$(c1ccc([#7])cc1):1][Cl]>>[c:1]O | # 3/69 |
| # -- ring_closure -- | | | |
| ring_closure_(hydroxyl-6bonds- | 0.244 | [OH1][C:2][*:3][*:4][*:5][C;!$(CC1OCC(O)C(O)C1O)](═O)- | # 11/45 |
| carboxyl) | | [OH1]>>O1[C:2][A:3][A:4][A:5]C1═O | |
| ring_closure_(NH1-6bonds- | 0.393 | [NH1;!$(NC═O):1][#6:2][*:3][*:4][*:5]C(═O)- | # 11/28 |
| carboxyl) | | [OH1]>>[N:1]1[#6:2][*:3][*:4][A:5]C1═O | |
| # -- hydrolysis -- | | | |
| hydrolysis_(methoxyester) | 0.457 | [C;$(C═O):1][O:2][CH3]>>[C:1][O:2] | # 32/70 |
| hydrolysis_(ester) | 0.356 | [#6!H3:1][C:2](=[O:3])O[#6!H3:4]>>[#6:1][C:2](=[O:3])O•O[#6:4] | # 206/579 |
| hydrolysis_(primary_amide) | 0.354 | [#6!H3:1][C:2](=[O:3])[NH2]>>[#6:1][C:2](=[O:3])O | # 23/65 |
| hydrolysis_(secondary_amide) | 0.087 | [#6!H3:1][C:2](=[O:3])[NH1:4][#6:5]>>[#6:1][C:2](=[O:3])O•[N:4][#6:5] | # 79/906 |
| hydrolysis_(tertiary_amide) | 0.106 | [#6!H3:1][C:2](=[O:3])[#7:4]([#6:5])[#6:6]>>[#6:1][C:2](=[O:3])O•[#7:4]([#6:5]) | # 54/508 |
| | | [#6:6] | |
| hydrolysis_(heteroatom_bonded_amide) | 0.117 | [#6!H3:1][C:2](=[O:3])[N:4][*;!#6:5]>>[#6:1][C:2](=[O:3])O•[N:4][*:5] | # 11/94 |
| hydrolysis_(urea_or_carbonate) | 0.047 | [N,O:1][C:2](=[O:3])[N,O:4][*:5]>>[N,O:1][C:2](=[O:3])O•[N,O:4][*:5] | # 43/908 |
| hydrolysis_(X = X- | 0.194 | [*:5][*;!#6;!$(S(═O)(═O)N);!$(P(O)(O)(O)═O):1](=[*;!#6:2])[N,O:3][*:4]>>[*:5] | # 37/191 |
| X_exclude_phosphate) | | [*:1](=[*:2])O•[N,O:3][*:4] | |
| hydrolysis_(CNC(OH)R) | 0.108 | [#6:1][N:2][CH1]([OH1])[*:3]>>[#6:1][N:2]•C(═O)[*:3] | # 4/37 |
| hydrolysis_(N-substituted-pyridine) | 0.022 | [n:2][c:3]!@[N;$(N(C)(C)c),$(NS(═O)═O):5]>>[n:2][c:3]O•[N:5] | # 7/323 |
| # -- N-oxidation -- | | | |
| N-oxidation_(tertiary_N) | 0.063 | [C;X4;!H3;!$(C(N)[!#6;!#1]):1][N;X3:2]([C;X4;!H3;!$(C(N)[!#6;!#1]):3])[C;X4;!H3;!$(C(N)[!#6;!#1]):4] | # 24/380 |
| | | >>[C:1][N+:2]([C:3])([C:4])[O—] | |
| N-oxidation_(tertiary_NCH3) | 0.185 | [C;X4;!H3;!$(C(N)[!#6;!#1]):1][N;X3:2]([CH3:3])[C;X4;!H3;!$(C(N)[!#6;!#1]):4] | # 32/173 |
| | | >>[C:1][N+:2]([C:3])([C:4])[O—] | |
| N-oxidation_(RN(CH3)2) | 0.212 | [C;X4;!$(C(N)[!#6;!#1]):1][N;X3:2]([CH3:3])[CH3:4]>>[C:1][N+:2]([C:3])([C:4]) | # 28/132 |
| | | [O—] | |
| N-oxidation_(—N═) | 0.024 | [#6:1][#7;X2;R:2]=[#6:3]>>[#6:1][#7+:2](=[#6:3])[O—] | # 22/922 |
| N-oxidation_(aniline) | 0.021 | [c:1][NH2:2]>>[c:1][N:2]O | # 4/195 |
| # -- acetyl_shift -- | | | |
| acetyl_shift | 0.074 | [#6:1][C:2](═O)O[C:5][C:6][OH1]>>[#6:1][C:2](═O)O[C:6][C:5]O | # 4/54 |
| # -- tautomerisation -- | | | |
| tautomerisation_(keto->enol) | 0.059 | [c:1][C:2](=[O:3])[CH2:4][#6:5]>>[c:1][C:2](-[O:3])=[C:4][#6:5] | # 2/34 |
| # -- special rules -- | | | |
| vinyl_oxidation | 0.238 | [#6:3][CH1:1]=[CH2:2]>>[#6:3][C:1](O)-[C:2]O | # 10/42 |
| oxidation_(amine_in_a_ring) | 0.045 | [CH2:1][CH2;R:2][N:3]>>[C:1][C:2](═O)[N:3] | # 39/862 |
| imine_hydrolysis | 0.037 | [#6:1][C:2]([#6:3])=[N;!$(N—N):4]>>[#6:1][C:2]([#6:3])═O•[N:4] | # 3/81 |
| hydrazone_hydrolysis | 0.125 | [C:2]=[N:4]−[N:5]>>[C:2]=O•[N:4]−[N:5] | # 10/80 |
| aromatic_oxidation | 0.022 | [#6:1][c:2]1[cH1:3][cH1:4][cH1:5][cH1:6][cH1:7]1>>[#6:1][c:2]1[c:3][c:4] | # 10/458 |
| | | (OC)[c:5](O)[c:6][c:7]1 | |
| phosphine_sulphide_hydrolysis | 0.438 | [P:1]=[S]>>[P:1]=[O] | # 7/16 |
| oxidation_to_quinone | 0.019 | [#7,O&H1:1][#6:2]:1:[#6:3]:[#6:4]:[#6:5](:[#6:6]:[#6:7]:1)[#7,O&H1:8]>>[#7,O:1]= | # 3/159 |
| | | [#6:2]-1-[#6:3]=[#6:4]−[#6:5](-[#6:6]=[#6:7]−1)=[#7,O&H0:8] | |
| oxidation_(C═N) | 0.075 | [NX2:1]=[CH1:2]>>[N:1]−[C:2]=O | # 4/53 |
| deiodonidation | 0.250 | [#6X3:1][l]>>[#6:1] | # 3/12 |
| nitrile_to_amide | 0.018 | [C:1]#N>>[C:1](═O)-N | # 1/55 |
| # -- steroids -- | | | |
| steroid_17hydroxy_to_keto | 0.077 | [C;$(C~1~C~2~C~C~C~3~C~4~C~C~C~C~C~4~C~C~C~3~C~2~C~C~1):17] | # 7/91 |
| | | ([OH1:30])!@[C:31]>>[C:17]=[OH1:30]•[C:31] | |
| ## --- Phase 2 reactions --- ## | | | |
| # -- O-glucuronidation -- | | | |
| O- | 0.091 | [C;!$(C1CCOCC1);!$(C1COCCC1);!$(C(O)═O):1][OH1:2]>>[C:1][O:2]C1OC | # |
| glucuronidation_(aliphatic_hydroxyl) | | (C(O)═O)C(O)C(O)C1O | 135/1486 |
| O- | 0.238 | [c:1][OH1:2]>>[c:1][O:2]C1OC(C(O)═O)C(O)C(O)C1O | # 157/659 |
| glucuronidation_(aromatic_hydroxyl) | | | |
| O- | 0.159 | [C:1][C;!$(C(O)(═O)C1OCCCC1):2](═O)[OH1]>>[C:1][C:2](═O)OC1OC | # 89/560 |
| glucuronidation_(aliphatic_carboxyl) | | (C(O)═O)C(O)C(O)C1O | |
| O- | 0.258 | [c:1][C:2](═O)[OH1]>>[c:1][C:2](═O)OC1OC(C(O)═O)C(O)C(O)C1O | # 23/89 |
| glucuronidation_(aromatic_carboxyl) | | | |
| # -- N-glucuronidation -- | | | |
| N-glucuronidation_(aniline) | 0.036 | [c:1][NH2;X3:2]>>[c:1][N:2]C1OC(C(O)═O)C(O)C(O)C1O | # 7/195 |
| N-glucuronidation_(aliphatic_NH2) | 0.014 | [C:1][NH2;X3:2]>>[C:1][N:2]C1OC(C(O)═O)C(O)C(O)C1O | # 5/354 |
| N-glucuronidation_(aniline_NH1-R) | 0.014 | [c:1][NH1;X3:2]>>[c:1][N:2]C1OC(C(O)═O)C(O)C(O)C1O | # 6/433 |
| N-glucuronidation_(N(CH3)2) | 0.080 | [N;X3;$(N([CH3])([CH3])[CH2]C):1]>>[N+:1]C1OC(C(O)═O)C(O)C(O)C1O | # 7/88 |
| N- | 0.026 | [N;X3;R;$(N(C)(C)[CH3]):1]>>[N+:1]C1OC(C(O)═O)C(O)C(O)C1O | # 6/228 |
| glucuronidation_(NCH3_in_a_ring) | | | |
| N-glucuronidation_(NH_in_a_ring) | 0.017 | [NH1;X3;R;$(N(C)C):1]>>[N:1]C1OC(C(O)═O)C(O)C(O)C1O | # 6/345 |
| N-glucuronidation_(aromatic_=n-) | 0.010 | [n;X2:1]>>[n+:1]C1OC(C(O)═O)C(O)C(O)C1O | # 10/1041 |
| N-glucuronidation_(aromatic_-nH-) | 0.062 | [nH1;X3:1]>>[n:1]C1OC(C(O)═O)C(O)C(O)C1O | # 9/146 |
| # -- sulfation -- | | | |
| sulfation_(aromatic_hydroxyl) | 0.097 | [c:1][OH1:2]>>[c:1][O:2]S(═O)(═O)O | # 64/659 |
| sulfation_(aniline) | 0.015 | [c:1][NH2:2]>>[c:1][N:2]S(═O)(═O)O | # 3/195 |
| sulfation_(aliphatic_hydroxyl) | 0.013 | [C;!$(C═O);!$(CC[OH1]):1][OH1:2]>>[C:1][O:2]S(═O)(═O)O | # 17/1329 |
| # -- N-acetylation -- | | | |
| N-acetylation_(aniline) | 0.349 | [c:1][NH2:2]>>[c:1][N:2]C(═O)C | # 68/195 |
| N-acetylation_(aliphatic_NH2) | 0.163 | [C;!$(C═[*;!#6]):1][NH2:2]>>[C:1][N:2]C(═O)C | # 30/184 |
| N- | 0.154 | [*;!#6:1][NH2:2]>>[*:1][N:2]C(═O)C | # 6/39 |
| acetylation_(heteroatom_bonded_NH2) | | | |
| N-acetylation_(NH1) | 0.014 | [C:1][NH1;R:2][C:3]>>[C:1][N:2]([C:3])C(═O)C | # 5/345 |
| N-acetylation_(NH1—CH3) | 0.028 | [CH3:1][NH1:2][C:3]>>[CH3:1][N:2]([C:3])C(═O)C | # 3/106 |
| # -- methylation -- | | | |
| methylation_(aromatic_OH) | 0.059 | [c:1][OH1:2]>>[c:1][O:2]C | # 39/659 |
| methylation_(thiol) | 0.300 | [#6:1][SH1:2]>>[#6:1][S:2]C | # 6/20 |
| # -- glycination -- | | | |
| glycination_(aromatic_carboxyl) | 0.135 | [c:1][C:2](═O)[OH1]>>[c:1][C:2](═O)NCC(═O)O | # 12/89 |
| glycination_(aliphatic_carboxyl) | 0.010 | [C:1][C:2](═O)[OH1]>>[C:1][C:2](═O)NCC(═O)O | # 6/586 |
| # -- phosphorylation -- | | | |
| phosphorylation | 0.383 | [OH1;$(O[CH2]C1AACO1),$(OP([OH1])(═O)OCC1AACO1),$(OP([OH1]) | # 18/47 |
| | | (═O)OP(O)(═O)OCC1AACO1):1]>>[O:1]P(O)(O)═O | |
| dephosphorylation | 0.255 | [*;#6,P:1][O:2][P:3]([O:4])([O:5])=[O:6]>>[*;#6,P:1][O:2]•O[P:3]([O:4])([O:5])= | # 24/94 |
| | | [O:6] | |

1. A system for predicting potential metabolites for a compound, comprising:
a user input device to allow a user to indicate a target compound to be analyzed for potential metabolites;
a data processor capable of applying a set of optimized reaction rules to said target compound to generate a list of potential metabolites and calculate a probability score for each potential metabolite;
means to make the resulting list of potential metabolites available to the user or to a further processing instrument.

2. The system according to claim 1, wherein said data processor comprises a filter that is capable of eliminating from said list of potential metabolites those metabolites having a calculated probability score that falls below a certain limit.

3. The system according to claim 1, wherein the set of reaction rules has one or more of the characteristics selected from the list consisting of:
a) the presence of 16 different rules for N-dealkylation;
b) the presence of separate rules for N-dealkylation of amines either connected to aromatic carbons or to aliphatic groups only;
c) the presence of different rules for hydroxylation of aliphatic carbons, one of those for a tertiary carbon, which should be attached to an sp2 hybridised atom and one of those for a secondary carbon in a ring attached to sp2 hybridised atoms on both sides;
d) the presence of a rule for ring-forming condensation reactions;
e) the presence of a rule for beta-oxidation of aliphatic carboxylic acids
f) the presence of a rule for glycination
g) the presence of a rule for phosphorylation
h) the presence of rules for specific reactions applicable to steroids;
i) the presence of rules for dehydrogenations which result in extension of a conjugated system in a molecule.

4. The system according to claim 1, wherein the set of reaction rules comprises a set of at least 10 different rules for hydroxylation, and with those rules at least two or more distinctions in hydroxylations are made selected for the list consisting of:
a) a distinction in aromatic, aliphatic and benzylic hydroxylation;
b) a distinction in aromatic hydroxylation of 5- and 6-membered aromatic rings;
c) a distinction in aromatic hydroxylation of aromatic carbon atoms positioned para, meta or ortho to non-hydrogen substituents;
d) a distinction in aromatic hydroxylation between aromatic carbon atoms positioned meta to non-hydrogen substituents and said aromatic carbon atoms being at the same time 1) either positioned ortho or para to another non-hydrogen substituent or 2) positioned ortho or para to a hydrogen atom;
e) a distinction in aromatic hydroxylation between aromatic carbons atoms positioned ortho to non-hydrogen substituents and said aromatic carbon atoms being at the same time a) either positioned meta or para to another non-hydrogen substituent or b) positioned meta or para to a hydrogen atom;
f) a distinction in aromatic hydroxylation of substituents connected to the aromatic system via a carbon, oxygen, nitrogen or any non-hydrogen atom;
g) a distinction in aromatic hydroxylation of nitrogen and sulfur containing 5-membered aromatic rings;
h) a distinction in hydroxylation of primary, secondary or tertiary aliphatic carbon atoms;
i) a distinction in hydroxylation of aliphatic carbon atoms connected to heteroatoms or carbon atoms;
j) a distinction in hydroxylation of aliphatic carbon atoms connected to aromatic carbon atoms, conjugated non-aromatic atoms, or aliphatic carbon atoms;
k) a distinction in hydroxylation of aliphatic carbon atoms connected to methyl groups or secondary, tertiary or quaternary carbon atoms;
l) a distinction in hydroxylation of aliphatic carbon atoms connected to atoms which are connected to methyl groups, heteroatoms, conjugated carbon atoms or aromatic carbon atoms;
m) a distinction in hydroxylation of aliphatic carbon atoms which are part of a ring and those which are not part of a ring.

5. The system according to claim 1, wherein the set of reaction rules comprises at least 10 rules for hydroxylation and at least one of those rules is selected from the list consisting of:
a) a rule for hydroxylation of an aromatic carbon in a 6-membered ring positioned para to another carbon;
b) a rule for hydroxylation of an aromatic carbon in a 6-membered ring positioned para to a nitrogen;
c) a rule for hydroxylation of an aromatic carbon in a 6-membered ring positioned para to an oxygen;
d) a rule for hydroxylation of an aromatic carbon in a 6-membered ring positioned meta to a carbon and not positioned para to a non-hydrogen atom;
e) a rule for hydroxylation of an aromatic carbon in a 6-membered ring positioned ortho to a carbon and not positioned para and/or ortho to a non-hydrogen atom;
f) a rule for hydroxylation of an aromatic carbon in a 6-membered ring positioned ortho to a nitrogen and not positioned para to a non-hydrogen atom;
g) a rule for hydroxylation of an aromatic carbon in a 6-membered ring positioned ortho to an oxygen and not positioned para to a non-hydrogen atom;
h) a rule for hydroxylation of an aromatic carbon in a 6-membered ring positioned ortho to two non-hydrogen substituents, one of which needs to be carbon, oxygen or nitrogen;
i) a rule for hydroxylation of an aromatic carbon atom in 5-membered ring connected to a sulfur in said ring;
j) a rule for hydroxylation of an aromatic carbon atom in 5-membered ring connected to a nitrogen in said ring;
k) a rule for hydroxylation of a primary aliphatic carbon connected to a quaternary carbon which is connected to at least one heteroatom;
l) a rule for hydroxylation of a primary aliphatic carbon connected to a tertiary carbon which is connected to at least methyl group;
m) a rule for hydroxylation of a primary aliphatic carbon connected to a secondary carbon;
n) a rule for hydroxylation of a primary aliphatic carbon connected to a carbon which is connected by either a double or a triple bond to yet another atom;
o) a rule for hydroxylation of a secondary aliphatic carbon connected to a methyl group and another tetravalent carbon;
p) a rule for hydroxylation of a secondary aliphatic ring carbon connected to two secondary carbons;
q) a rule for hydroxylation of a secondary aliphatic ring carbon connected to a secondary carbon and another tetravalent non-secondary carbon which is connected to either a methyl group or a heteroatom;
r) a rule for hydroxylation of a secondary aliphatic non-ring, non-benzylic carbon connected to a tetravalent carbon and another atom which is connected by a double bond to yet another atom;
s) a rule for hydroxylation of a secondary aliphatic non-benzylic ring carbon connected to a tetravalent carbon and another atom which is either a nitrogen or connected by a double bond to yet another atom;
t) a rule for hydroxylation of a secondary aliphatic non-benzylic ring carbon connected to two atoms which are connected by a double bond to yet another atom;
u) a rule for hydroxylation of a tertiary carbon connected to two aliphatic carbons, one of which is connected to either a nitrogen atom or a carbon atom connected by a double bond to yet another atom;
v) a rule for hydroxylation of a non-benzylic tertiary carbon connected to two methyl groups;
w) a rule for hydroxylation of a benzylic methyl group.

6. A method for predicting potential metabolites for a compound, comprising the steps of:
receiving a target compound;
applying a set of optimized reaction rules to said target compound to generate a list of potential metabolites;
calculating a probability score for each potential metabolite on said list of potential metabolites.

7. The method according to claim 6, wherein the set of reaction rules has one or more of the characteristics selected from the list consisting of:
a) the presence of 16 different rules for N-dealkylation;
b) the presence of separate rules for N-dealkylation of amines either connected to aromatic carbons or to aliphatic groups only;
c) the presence of different rules for hydroxylation of aliphatic carbons, one of those for a tertiary carbon, which should be attached to an sp2 hybridised atom and one of those for a secondary carbon in a ring attached to sp2 hybridised atoms on both sides;
d) the presence of a rule for ring-forming condensation reactions;
e) the presence of a rule for beta-oxidation of aliphatic carboxylic acids
f) the presence of a rule for glycination
g) the presence of a rule for phosphorylation
h) the presence of rules for specific reactions applicable to steroids;
i) the presence of rules for dehydrogenations which result in extension of a conjugated system in a molecule.

8. The method according to claim 6, wherein the set of reaction rules comprises a set of at least 10 different rules for hydroxylation, and with those rules at least two or more distinctions in hydroxylations are made selected for the list consisting of:
a) a distinction in aromatic, aliphatic and benzylic hydroxylation;
b) a distinction in aromatic hydroxylation of 5- and 6-membered aromatic rings;
c) a distinction in aromatic hydroxylation of aromatic carbon atoms positioned para, meta or ortho to non-hydrogen substituents;
d) a distinction in aromatic hydroxylation between aromatic carbon atoms positioned meta to non-hydrogen substituents and said aromatic carbon atoms being at the same time 1) either positioned ortho or para to another non-hydrogen substituent or 2) positioned ortho or para to a hydrogen atom;
e) a distinction in aromatic hydroxylation between aromatic carbons atoms positioned ortho to non-hydrogen substituents and said aromatic carbon atoms being at the same time a) either positioned meta or para to another non-hydrogen substituent or b) positioned meta or para to a hydrogen atom;
f) a distinction in aromatic hydroxylation of substituents connected to the aromatic system via a carbon, oxygen, nitrogen or any non-hydrogen atom;
g) a distinction in aromatic hydroxylation of nitrogen and sulfur containing 5-membered aromatic rings;
h) a distinction in hydroxylation of primary, secondary or tertiary aliphatic carbon atoms;
i) a distinction in hydroxylation of aliphatic carbon atoms connected to heteroatoms or carbon atoms;
j) a distinction in hydroxylation of aliphatic carbon atoms connected to aromatic carbon atoms, conjugated non-aromatic atoms, or aliphatic carbon atoms;
k) a distinction in hydroxylation of aliphatic carbon atoms connected to methyl groups or secondary, tertiary or quaternary carbon atoms;
l) a distinction in hydroxylation of aliphatic carbon atoms connected to atoms which are connected to methyl groups, heteroatoms, conjugated carbon atoms or aromatic carbon atoms;
m) a distinction in hydroxylation of aliphatic carbon atoms which are part of a ring and those which are not part of a ring.

9. The method according to claim 6, wherein the set of reaction rules comprises at least 10 rules for hydroxylation and at least one of those rules is selected from the list consisting of:
a) a rule for hydroxylation of an aromatic carbon in a 6-membered ring positioned para to another carbon;
b) a rule for hydroxylation of an aromatic carbon in a 6-membered ring positioned para to a nitrogen;
c) a rule for hydroxylation of an aromatic carbon in a 6-membered ring positioned para to an oxygen;
d) a rule for hydroxylation of an aromatic carbon in a 6-membered ring positioned meta to a carbon and not positioned para to a non-hydrogen atom;
e) a rule for hydroxylation of an aromatic carbon in a 6-membered ring positioned ortho to a carbon and not positioned para and/or ortho to a non-hydrogen atom;
f) a rule for hydroxylation of an aromatic carbon in a 6-membered ring positioned ortho to a nitrogen and not positioned para to a non-hydrogen atom;
g) a rule for hydroxylation of an aromatic carbon in a 6-membered ring positioned ortho to an oxygen and not positioned para to a non-hydrogen atom;
h) a rule for hydroxylation of an aromatic carbon in a 6-membered ring positioned ortho to two non-hydrogen substituents, one of which needs to be carbon, oxygen or nitrogen;
i) a rule for hydroxylation of an aromatic carbon atom in 5-membered ring connected to a sulfur in said ring;
j) a rule for hydroxylation of an aromatic carbon atom in 5-membered ring connected to a nitrogen in said ring;
k) a rule for hydroxylation of a primary aliphatic carbon connected to a quaternary carbon which is connected to at least one heteroatom;
l) a rule for hydroxylation of a primary aliphatic carbon connected to a tertiary carbon which is connected to at least methyl group;
m) a rule for hydroxylation of a primary aliphatic carbon connected to a secondary carbon;
n) a rule for hydroxylation of a primary aliphatic carbon connected to a carbon which is connected by either a double or a triple bond to yet another atom;
o) a rule for hydroxylation of a secondary aliphatic carbon connected to a methyl group and another tetravalent carbon;
p) a rule for hydroxylation of a secondary aliphatic ring carbon connected to two secondary carbons;
q) a rule for hydroxylation of a secondary aliphatic ring carbon connected to a secondary carbon and another tetravalent non-secondary carbon which is connected to either a methyl group or a heteroatom;
r) a rule for hydroxylation of a secondary aliphatic non-ring, non-benzylic carbon connected to a tetravalent carbon and another atom which is connected by a double bond to yet another atom;
s) a rule for hydroxylation of a secondary aliphatic non-benzylic ring carbon connected to a tetravalent carbon and another atom which is either a nitrogen or connected by a double bond to yet another atom;
t) a rule for hydroxylation of a secondary aliphatic non-benzylic ring carbon connected to two atoms which are connected by a double bond to yet another atom;
u) a rule for hydroxylation of a tertiary carbon connected to two aliphatic carbons, one of which is connected to either a nitrogen atom or a carbon atom connected by a double bond to yet another atom;
v) a rule for hydroxylation of a non-benzylic tertiary carbon connected to two methyl groups;
w) a rule for hydroxylation of a benzylic methyl group.

10. A method to identify the metabolites of a drug in a mammalian body by entering the structural formula of the drug into a computer program, which computer program provides the structural formulas of possible metabolites by screening for possible metabolic transformations and the probabilities thereof for the drug by using a list of possible metabolic transformations and the corresponding probabilities of those transformations, characterized in that the list contains subsets of metabolic transformation depending on the position of the modified part of the drug in the structure of the drug.

11. The method according to claim 10, wherein the method is implemented in a computer connected to a mass spectrometer for adjustment of the mass identification mechanism of fragments.

12. A method of making an optimized set of reaction rules from a starting set of reaction rules for use in the system according to claim 1, which method of making an optimized set of reaction rules comprises the step of replacing at least one reaction rule for a reaction center in said starting set of reaction rules by one or more new rules, which are defined to apply to a reaction of said reaction center, but now specifying or differentiating based on the structural environments of said reaction center, if at least one of said new rules has a higher probability score than the replaced reaction rule when the starting set of reaction rules and the optimized set of reaction rules are both tested with a database of known metabolites of compounds.
